(19) United States
(12) Patent Application Publication
(10) Pub. No.: US 2025/0274611 A1
(43) Pub. Date: Aug. 28, 2025

(54) Method For Signaling Media Usability For Neural Networks

(71) Applicant: Nokia Technologies Oy, Espoo (FI)

(72) Inventors: Lukasz Kondrad, Munich (DE); Emre Baris Aksu, Tampere (FI); Kashyap Kammachi Sreedhar, Tampere (FI); Miska Matias Hannuksela, Tampere (FI); Lauri Aleksi ILOLA, Tampere (FI)

(21) Appl. No.: 19/064,056

(22) Filed: Feb. 26, 2025

Related U.S. Application Data
(60) Provisional application No. 63/558,902, filed on Feb. 28, 2024.

(51) Int. Cl. H04N 19/70; H04N 19/42

(52) U.S. Cl. CPC H04N 19/70; H04N 19/42

(57) ABSTRACT

An apparatus includes at least one processor; and at least one memory storing instructions that, when executed by the at least one processor, cause the apparatus at least to: determine information related to a usability of at least one image with an artificial intelligence model; and signal the information related to the usability of the at least one image with an artificial intelligence model.

### RELATED APPLICATION

This application claims priority to U.S. Provisional Application No. 63/558,902, filed Feb. 28, 2024, which is herein incorporated by reference in its entirety.

### TECHNICAL FIELD

The examples and non-limiting embodiments relate generally to multimedia transport and, more particularly, to a method for signaling media usability for neural networks.

### BACKGROUND

It is known to perform data compression and data decompression in a multimedia system.

### SUMMARY

In accordance with an aspect, an apparatus includes at least one processor; and at least one memory storing instructions that, when executed by the at least one processor, cause the apparatus at least to: determine information related to a usability of at least one image with an artificial intelligence model; and signal the information related to the usability of the at least one image with an artificial intelligence model.

In accordance with an aspect, an apparatus includes at least one processor; and at least one memory storing instructions that, when executed by the at least one processor, cause the apparatus at least to: receive signaling of information related to a usability of at least one image with an artificial intelligence model; and determine whether to use the at least one image with an artificial intelligence model, based on the received signaling.

In accordance with an aspect, a method includes determining information related to a usability of at least one image with an artificial intelligence model; and signaling the information related to the usability of the at least one image with an artificial intelligence model.

### BRIEF DESCRIPTION OF THE DRAWINGS

The foregoing embodiments and other features are explained in the following description, taken in connection with the accompanying drawings, wherein:

FIG. 1 shows an example syntax element indicating to what extent decoded pictures within the scope of an EOI SEI message are suitable for training of AI models.

FIG. 2 is a block diagram illustrating a system in accordance with an example.

FIG. 3 is an example apparatus configured to implement the examples described herein.

FIG. 4 shows a representation of an example of non-volatile memory media used to store instructions that implement the examples described herein.

FIG. 5 is an example method, based on the examples described herein.

FIG. 6 is an example method, based on the examples described herein.

### DETAILED DESCRIPTION OF EXAMPLE EMBODIMENTS

### ISOBMFF—ISO/IEC 14496-12

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO base media file format, a file includes media data and metadata that are encapsulated into boxes. Each box is identified by a four character code (4CC) and starts with a header which informs about the type and size of the box.

Many files formatted according to the ISO base media file format start with a file type box, also referred to as FileTypeBox or the ftyp box. The ftyp box contains information of the brands labeling the file. The ftyp box includes one major brand indication and a list of compatible brands. The major brand identifies the most suitable file format specification to be used for parsing the file. The compatible brands indicate which file format specifications and/or conformance points the file conforms to. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box. A file player may check if the ftyp box of a file comprises brands it supports, and may parse and play the file only if any file format specification supported by the file player is listed among the compatible brands.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they contain an elementary media stream. Other track types comprise hint tracks and timed metadata tracks.

Tracks comprise samples, such as audio or video frames, or metadata frames. For video tracks, a media sample may correspond to a coded picture or an access unit. A media track refers to samples (which may also be referred to as media samples) formatted according to a media compression format (and its encapsulation to the ISO base media file format). A hint track refers to hint samples, containing cookbook instructions for constructing packets for transmission over an indicated communication protocol. A timed metadata track may refer to samples describing referred media and/or hint samples.

The ‘trak’ box includes in its hierarchy of boxes the SampleTableBox (also known as the sample table or the sample table box). The SampleTableBox contains the SampleDescriptionBox, which gives detailed information about the coding type used, and any initialization information needed for that coding. The SampleDescriptionBox contains an entry-count and as many sample entries as the entry-count indicates. The format of sample entries is track-type specific but derive from generic classes (e.g. VisualSampleEntry, AudioSampleEntry, VolumetricVisualSampleEntry). The type of sample entry form used for derivation the track-type specific sample entry format is determined by the media handler of the track.

Movie fragments may be used, for example, when recording content to ISO files, for example, in order to avoid losing data if a recording application crashes, runs out of memory space, or some other incident occurs. Without movie fragments, data loss may occur because the file format may require that all metadata, for example, a movie box, be written in one contiguous area of the file. Furthermore, when recording a file, there may not be sufficient amount of memory space to buffer a movie box for the size of the storage available, and re-computing the contents of a movie box when the movie is closed may be too slow. Moreover, movie fragments may enable simultaneous recording and playback of a file using a regular ISO file parser. Furthermore, a smaller duration of initial buffering may be required for progressive downloading, e.g., simultaneous reception and playback of a file when movie fragments are used and the initial movie box is smaller compared to a file with the same media content but structured without movie fragments.

The movie fragment feature may enable splitting the metadata that otherwise might reside in the movie box into multiple pieces. Each piece may correspond to a certain period of time of a track. In other words, the movie fragment feature may enable interleaving file metadata and media data. Consequently, the size of the movie box may be limited and the use cases mentioned above be realized.

In some examples, the media samples for the movie fragments may reside in an mdat box. For the metadata of the movie fragments, however, a moof box may be provided. The moof box may include the information for a certain duration of playback time that would previously have been in the moov box. The moov box may still represent a valid movie on its own, but in addition, it may include an mvex box indicating that movie fragments will follow in the same file. The movie fragments may extend the presentation that is associated to the moov box in time.

Within the movie fragment there may be a set of track fragments, including anywhere from zero to a plurality per track. The track fragments may in turn include anywhere from zero to a plurality of track runs, each of which document is a contiguous run of samples for that track (and hence are similar to chunks). Within these structures, many fields are optional and can be defaulted. The metadata that may be included in the moof box may be limited to a subset of the metadata that may be included in a moov box and may be coded differently in some cases. Details regarding the boxes that can be included in a moof box may be found from the ISOBMFF specification.

A self-contained movie fragment may be defined to consist of a moof box and an mdat box that are consecutive in the file order and where the mdat box contains the samples of the movie fragment (for which the moof box provides the metadata) and does not contain samples of any other movie fragment (i.e. any other moof box). A media segment may comprise one or more self-contained movie fragments. A media segment may be used for delivery, such as streaming, e.g. in MPEG-Dynamic Adaptive Streaming over Hypertext Transfer Protocol (HTTP) (MPEG-DASH).

The track reference mechanism can be used to associate tracks with each other. The TrackReferenceBox includes box(es), each of which provides a reference from the containing track to a set of other tracks. These references are labelled through the box type (i.e. the four-character code of the box) of the contained box(es). The ISO Base Media File Format contains three mechanisms for timed metadata that can be associated with particular samples: sample groups, timed metadata tracks, and sample auxiliary information. Derived specification may provide similar functionality with one or more of these three mechanisms.

TrackGroupBox, which is contained in TrackBox, enables indication of groups of tracks where each group shares a particular characteristic or the tracks within a group have a particular relationship. The box contains zero or more boxes, and the particular characteristic or the relationship is indicated by the box type of the contained boxes. The contained boxes include an identifier, which can be used to conclude the tracks belonging to the same track group. The tracks that contain the same type of a contained box within the TrackGroupBox and have the same identifier value within these contained boxes belong to the same track group.

The ISO Base Media File Format contains three mechanisms for timed metadata that can be associated with particular samples: sample groups, timed metadata tracks, and sample auxiliary information. Derived specification may provide similar functionality with one or more of these three mechanisms.

A sample grouping in the ISO base media file format and its derivatives, such as the AVC file format and the scalable video coding (SVC) file format, may be defined as an assignment of each sample in a track to be a member of one sample group, based on a grouping criterion. A sample group in a sample grouping is not limited to being contiguous samples and may contain non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) contains a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g. to indicate a sub-type of the grouping.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is stored in the same file as the samples to which it relates as they share the same data reference (‘dref’) structure. However, this data may be located anywhere within this file, using auxiliary information offsets (‘saio’) to indicate the location of the data.

The restricted video (‘resv’) sample entry and mechanism has been specified for the ISOBMFF in order to handle situations where the file author requires certain actions on the player or renderer after decoding of a visual track. Players not recognizing or not capable of processing the required actions are stopped from decoding or rendering the restricted video tracks. The ‘resv’ sample entry mechanism applies to any type of video codec. A RestrictedSchemeInfoBox is present in the sample entry of ‘resv’ tracks and comprises an OriginalFormatBox, SchemeTypeBox, and SchemeInformationBox. The original sample entry type that would have been unless the ‘resv’ sample entry type were used is contained in the OriginalFormatBox. The SchemeTypeBox provides an indication which type of processing is required in the player to process the video. The SchemeInformationBox comprises further information of the required processing. The scheme type may impose requirements on the contents of the SchemeInformationBox. For example, the stereo video scheme indicated in the SchemeTypeBox indicates that when decoded frames either contain a representation of two spatially packed constituent frames that form a stereo pair (frame packing) or only one view of a stereo pair (left and right views in different tracks). StereoVideoBox may be contained in SchemeInformationBox to provide further information e.g. on which type of frame packing arrangement has been used (e.g. side-by-side or top-bottom).

Several types of stream access points (SAPs) have been specified, including the following. SAP Type 1 corresponds to what is known in some coding schemes as a “Closed group of pictures (GOP) random access point” (in which all pictures, in decoding order, can be correctly decoded, resulting in a continuous time sequence of correctly decoded pictures with no gaps) and in addition the first picture in decoding order is also the first picture in presentation order. SAP Type 2 corresponds to what is known in some coding schemes as a “Closed GOP random access point” (in which all pictures, in decoding order, can be correctly decoded, resulting in a continuous time sequence of correctly decoded pictures with no gaps), for which the first picture in decoding order may not be the first picture in presentation order. SAP Type 3 corresponds to what is known in some coding schemes as an “Open GOP random access point”, in which there may be some pictures in decoding order that cannot be correctly decoded and have presentation times less than intra-coded picture associated with the SAP.

A stream access point (SAP) sample group as specified in ISOBMFF identifies samples as being of the indicated SAP type.

A sync sample may be defined as a sample corresponding to SAP type 1 or 2. A sync sample can be regarded as a media sample that starts a new independent sequence of samples; if decoding starts at the sync sample, it and succeeding samples in decoding order can all be correctly decoded, and the resulting set of decoded samples forms the correct presentation of the media starting at the decoded sample that has the earliest composition time. Sync samples can be indicated with the SyncSampleBox (for those samples whose metadata is present in a TrackBox) or within sample flags indicated or inferred for track fragment runs.

Files conforming to the ISOBMFF may contain any non-timed objects, referred to as items, meta items, or metadata items, in a meta box (fourCC: ‘meta’), which may also be called MetaBox. While the name of the meta box refers to metadata, items can generally contain metadata or media data. The meta box may reside at the top level of the file, within a movie box (fourCC: ‘moov’), and within a track box (fourCC: ‘trak’), but at most one meta box may occur at each of the file level, movie level, or track level. The meta box may be required to contain a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. If the metadata is located external to the file then its location may be declared by the DataInformationBox (fourCC: ‘dinf’). In the specific case that the metadata is formatted using XML syntax and is required to be stored directly in the MetaBox, the metadata may be encapsulated into either the XMLBox (fourCC: ‘xml’) or the BinaryXMLBox (fourcc: ‘bxml’). An item may be stored as a contiguous byte range, or it may be stored in several extents, each being a contiguous byte range. In other words, items may be stored fragmented into extents, e.g. to enable interleaving. An extent is a contiguous subset of the bytes of the resource; the resource can be formed by concatenating the extents.

High Efficiency Image File Format (HEIF) is a standard developed by the Moving Picture Experts Group (MPEG) for storage of images and image sequences. Among other things, the standard facilitates file encapsulation of data coded according to High Efficiency Video Coding (HEVC) standard. HEIF includes features building on top of the used ISO Base Media File Format (ISOBMFF).

The ISOBMFF structures and features are used to a large extent in the design of HEIF. The basic design for HEIF comprises that still images are stored as items and image sequences are stored as tracks.

In the context of HEIF, the following boxes may be contained within the root-level ‘meta’ box and may be used as described in the following. In HEIF, the handler value of the Handler box of the ‘meta’ box is ‘pict’. The resource (whether within the same file, or in an external file identified by a uniform resource identifier) containing the coded media data is resolved through the Data Information (‘dinf’) box, whereas the Item Location (‘iloc’) box stores the position and sizes of every item within the referenced file. The Item Reference (‘iref’) box documents relationships between items using typed referencing. If there is an item among a collection of items that is in some way to be considered the most important compared to others then this item is signaled by the Primary Item (‘pitm’) box. Apart from the boxes mentioned here, the ‘meta’ box is also flexible to include other boxes that may be necessary to describe items.

Any number of image items can be included in the same file. Given a collection of images stored by using the ‘meta’ box approach, it sometimes is essential to qualify certain relationships between images. Examples of such relationships include indicating a cover image for a collection, providing thumbnail images for some or all of the images in the collection, and associating some or all of the images in a collection with auxiliary image such as an alpha plane. A cover image among the collection of images is indicated using the ‘pitm’ box. A thumbnail image or an auxiliary image is linked to the primary image item using an item reference of type ‘thmb’ or ‘auxl’, respectively.

The ItemPropertiesBox enables the association of any item with an ordered set of item properties. Item properties are small data records. The ItemPropertiesBox consists of two parts: ItemPropertyContainerBox that contains an implicitly indexed list of item properties, and one or more ItemPropertyAssociationBox(es) that associate items with item properties. Item property is formatted as a box.

A descriptive item property may be defined as an item property that describes rather than transforms the associated item. A transformative item property may be defined as an item property that transforms the reconstructed representation of the image item content.

An entity may be defined as a collective term of a track or an item. An entity group is a grouping of items, which may also group tracks. An entity group can be used instead of item references, when the grouped entities do not have clear dependency or directional reference relation. The entities in an entity group share a particular characteristic or have a particular relationship, as indicated by the grouping type.

An entity group is a grouping of items, which may also group tracks. The entities in an entity group share a particular characteristic or have a particular relationship, as indicated by the grouping type.

Entity groups are indicated in GroupsListBox. Entity groups specified in GroupsListBox of a file-level MetaBox refer to tracks or file-level items. Entity groups specified in GroupsListBox of a movie-level MetaBox refer to movie-level items. Entity groups specified in GroupsListBox of a track-level MetaBox refer to track-level items of that track. GroupsListBox contains EntityToGroupBoxes, each specifying one entity group.

The File Format group in MPEG have been working on a new design of HEIF file format tailored for small images. This new design of HEIF may be called Reduced Header Mode or Slim HEIF. The slim HEIF design reduces the header/metadata overhead which comes when using the MetaBox with version=0 and all the child boxes within the MetaBox to represent image items.

The slim HEIF design may use the MinimizedImageBox as defined below or a variation of this box including the contents which are currently defined in this MinimizedImageBox.

### Minimized Image Box

Box Type: ‘mini’
Container: file
Mandatory: No
Quantity: At most one

The minimized image box provides a more compact way to represent the carrying of image items in a file. Its main use case is for very small images where the traditional carriage using the MetaBox would result in considerable overhead compared to the image data payload.

When MinimizedImageBox is present, a file-level MetaBox shall not be present in the file. However, some parts of the body of a MetaBox may be embedded in the MinimizedImageBox when the has_extended_meta flag is set to one.

The major_brand of the FileTypeBox may be specified in derived specifications to signal pre-defined values for infe_type and codec_config_type. However, if no such codec specific brand exists, the ‘mini’ brand may be used, in which case has_explicit_codec_types shall be set to 1.

A file that contains a MinimizedImageBox shall have major_brand of the FileTypeBox set to ‘mini’, or to a derived specification's brand that conforms to the ‘mini’ brand.

The MinimizedImageBox may be followed by a MovieBox.

The MinimizedImageBox may be followed by a MediaDataBox.

A file with a MinimizedImageBox can be expanded to a full file-level MetaBox, treated as if the MetaBox was originally present. Syntax of MinimizedImageBox is as follows:

```
function varint( ) {
  bit(7) value;
  bit(1) extended;
  if (!extended) return value;
  bit(3) extension;
  bit(1) extended2;
  if (!extended2) return ((extension+1)<<7) + value;
  bit(18) extension2;
  return ((extension2+1)<<(7+3)) + ((extension+1)<<7) + value;
}
aligned(8) class MinimizedImageBox extends Box(‘mini’) {
  bit(2) version;
  varint width_minus_one;
  varint height_minus_one;
  // Colour and bit-depth
  bit(1) is_float;
  if (is_float) {
    bit(2) float_precision;
  }
  else {
    bit(4) bit_depth_minus_one;
  }
  bit(2) subsampling;
  if (subsampling >= 2) {
    bit(1) is_centered;
  }
  bit(1) full_range;
  bit(2) colour_type;
  if (colour_type == 0) {
    colour_primaries = 1;
    transfer_characteristics = 13;
    if (subsampling > 0) {
      matrix_coefficients = 6;
    }
    else {
      matrix_coefficients = 2;
    }
  }
  else if (colour_type == 1) {
    bit(5) colour_primaries;
    bit(5) transfer_characteristics;
    if (subsampling > 0) {
      bit(5) matrix_coefficients;
    }
    else {
      matrix_coefficients = 2;
    }
  }
  else if (colour_type == 2) {
    bit(8) colour_primaries;
    bit(8) transfer_characteristics;
    if (subsampling > 0) {
      bit(8) matrix_coefficients;
    }
    else {
      matrix_coefficients = 2;
    }
  }
  else {
    colour_primaries = 2;
    transfer_characteristics = 2;
    if (subsampling > 0) {
      bit(8) matrix_coefficients;
    }
    else {
      matrix_coefficients = 2;
    }
    varint icc_data_size_minus_one;
  }
  // Item metadata
  bit(1) has_explicit_codec_types;
  if (has_explicit_codec_types) {
    unsigned int(32) infe_type;
    unsigned int(32) codec_config_type;
  }
  varint main_item_codec_config_size;
  varint main_item_data_size_minus_one;
  // Other items
  bit(1) has_alpha;
  if (has_alpha) {
    bit(1) alpha_is_premultiplied;
    varint alpha_item_codec_config_size;
    varint alpha_item_data_size;
  }
  Boolean has_separate_alpha_item=has_alpha && alpha_item_data_size>0;
  bit(1) has_extended_meta;
  if (has_extended_meta) {
    varint extended_meta_size_minus_one;
  }
  bit(1) has_exif;
  if (has_exif) {
    varint exif_data_size_minus_one;
  }
  bit(1) has_xmp;
  if (has_xmp) {
    varint xmp_data_size_minus_one;
  }
  // Pad bits until byte-aligned
  trailing_bits( );
  // Payload data
  // Codec config body data for alpha and main
  if (has_alpha && alpha_item_codec_config_size > 0) {
    unsigned int(8) alpha_item_codec_config[alpha_item_codec_config_size];
  }
  unsigned int(8) main_item_codec_config[main_item_codec_config_size];
  // Extended ‘meta’ box
  if (has_extended_meta) {
    unsigned int(8) extended_meta[extended_meta_size_minus_one + 1];
  }
  // ICC profile data
  if (colour_type == 3) {
    unsigned int(8) icc_data[icc_data_size_minus_one + 1];
  }
  // Alpha and main elementary stream payloads
  if (has_separate_alpha_item) {
    unsigned int(8) alpha_data[alpha_item_data_size];
  }
  unsigned int(8) main_data[main_item_data_size_minus_one + 1];
  // Metadata payloads
  if (has_exif) {
    unsigned int(8) exif_data[exif_data_size_minus_one + 1];
  }
  if (has_xmp) {
    unsigned int(8) xmp_data[xmp_data_size_minus_one + 1];
  }
}
```

Semantics of MinimizedImageBox is as follows:
version: version of the MinimizedImageBox. The current version shall be set to 0.
width_minus_one: specifies the width minus one of the reconstructed image in pixels, as specified in ImageSpatialExtentsProperty
height_minus_one: specifies the height minus one of the reconstructed image in pixels, as specified in ImageSpatialExtentsProperty
is_float: specifies whether float_precision or bit_depth_minus_one is signaled. If is_float is set to 1, it indicates that the float_precision is signaled, otherwise bit_depth_minus_one is signaled.
float_precision: specifies the format of floating-point numbers used for the pixel values as defined by IEEE 754-2008. The values 0, 1, and 2 correspond to half-precision float (binary16), single-precision float (binary32), and double-precision float (binary64) formats, respectively. Other values are reserved for a future specification. When is_float is set to 0, the value is undefined.
bit_depth_minus_one: indicates the number of bits, minus one, per channel for the pixels of the reconstructed main and alpha image items, as specified in PixelInformationProperty.
subsampling: when set to 0, indicates that there is exactly one channel of coded color samples, as specified by the num_channels field of the PixelInformationProperty in clause 6.5.6. When set to a non-zero value it indicates that there are exactly three channels of coded color samples. A value of 1 indicates that there is no subsampling of chroma (i.e. 4:4:4). A value of 2 indicates that chroma is subsampled by a factor 2 horizontally (i.e. 4:2:2). A value of 3 indicates that chroma is subsampled both horizontally and vertically by a factor 2 (i.e. 4:2:0). If has_alpha is 1 and alpha_item_codec_config_size is 0, the number of channels will be two and four respectively.
is_centered: 0 indicates that the chroma samples are co-located with the luma samples. A value of 1 indicates that the chroma samples are centered between the luma samples.
full_range: carries a VideoFullRangeFlag value as defined in ISO/IEC 23091-2
colour_type: specifies the color encoding type. When set to 0 it indicates the default values of MIAF (1/13/6). When set to 1 or 2 it implies the on-screen colors as signaled in ColourInformationBox with colour_type=‘nclx’. When set to 3 it indicates that an ICC Profile and matrix coefficients are present.
colour_primaries: carries a ColourPrimaries value as defined in ISO/IEC 23091-2
transfer_characteristics: carries a TransferCharacteristics value as defined in ISO/IEC 23091-2
matrix_coefficients: carries a MatrixCoefficients value as defined in ISO/IEC 23091-2
icc_data_size_minus_one: specifies the size of ICC profile data minus one when the colour_type field indicates it is present in bytes. Undefined if the value of colour_type is not equal to 3.
has_explicit_codec_types: when set to 1 indicates that both infe_type and codec_config_type are explicitly signaled, otherwise their types are implied from the major_brand of the FileTypeBox. Shall be set to 1 if major_brand does not explicitly specify their default values.
infe_type: corresponds to the item_type field of the version 2 of the ItemInfoEntry box. Defined by the major brand if has_explicit_codec_types is set to 0.
codec_config_type: corresponds to the codec configuration box type. Defined by the major brand if has_explicit_codec_types is set to 0.
main_item_codec_config_size: specifies the size of the configuration for the main image item.
main_item_data_size_minus_one: specifies the size minus one of the data for the main image item in bytes.
has_alpha: when set to 0 indicates that the image is opaque, otherwise the image has an alpha layer, whether the codec has native translucency support, or an auxiliary image item is used.
alpha_is_premultiplied: when set to 1 indicates that main values are pre-multiplied by alpha, otherwise main values are not pre-multiplied.
alpha_item_codec_config_size: specifies the size of the configuration for the alpha image item in bytes. When set to 0 indicates that the codec does not need any configuration data for alpha or can reuse the one from the main image. The value is set to 0 if has_alpha is 0.
alpha_item_data_size: specifies the size of the data for the alpha image item in bytes. If has_alpha is set to 1, the value 0 indicates that the codec has native translucency support and that the alpha samples are coded alongside the color samples in the main_data chunk. Zero if has_alpha is not set to 1.
has_extended_meta: when set to 1 indicates the presence of extended metadata within the MinimizedImageBox, otherwise it indicates the absence of it.
extended_meta_size_minus_one: specifies the size minus one of the extended metadata in bytes. Undefined if has_extended_meta is not set to 1.
has_exif: when set to 1 indicates the presence of an Exif metadata chunk, otherwise it indicates the absence of it.
exif_data_size_minus_one: specifies the size minus one of the Exif metadata in bytes. −1 if has_exif is not set to 1.
has_xmp: when set to 1 indicates the presence of an XMP metadata chunk, otherwise it indicates the absence of it.
xmp_data_size_minus_one: specifies the size minus one of the XMP metadata in bytes. −1 if has_xmp is not set to 1.
trailing_bits: padding bits to ensure payloads are 8-bit aligned. Shall be 0.
alpha_item_codec_config: specifies the optional alpha image codec configuration data. When has_alpha is set to 0 or alpha_item_codec_config_size is 0, alpha_item_codec_config is not present.
main_item_codec_config: specifies the main image item codec configuration data. When main_item_codec_config_size is 0, main_item_codec_config is not present.
extended_meta: specifies the optional extended metadata. When has_extended_meta is set to 0 extended_meta is not present.
icc_data: specifies the optional ICC profile data. When colour_type is not set to 3 icc_data is not present.
alpha_data: specifies the optional alpha image data. When has_alpha is set to 0 or alpha_item_data_size is 0, alpha_data is not present.
main_data: specifies the main image data.
exif_data: specifies the optional Exif metadata. When has_exif is set to 0 exif_data is not present.
xmp_data: specifies the optional XMP metadata. When has_xmp is set to 0 xmp_data is not present.
   Dynamic Adaptive Streaming with HTTP (DASH)

Hypertext Transfer Protocol (HTTP) has been widely used for the delivery of real-time multimedia content over the Internet, such as in video streaming applications.

Several commercial solutions for adaptive streaming over HTTP, such as Microsoft® Smooth Streaming, Apple® Adaptive HTTP Live Streaming and Adobe® Dynamic Streaming, have been launched as well as standardization projects have been carried out. Adaptive HTTP streaming (AHS) was first standardized in Release 9 of 3rd Generation Partnership Project (3GPP) packet-switched streaming (PSS) service (3GPP TS 26.234 Release 9: ‘Transparent end-to-end packet-switched streaming service (PSS); protocols and codecs’). MPEG took 3GPP AHS Release 9 as a starting point for the MPEG DASH standard (ISO/IEC 23009-1: ‘Dynamic adaptive streaming over HTTP (DASH)-Part 1: Media presentation description and segment formats,’ International Standard, 2nd Edition, 2014). 3GPP continued to work on adaptive HTTP streaming in communication with MPEG and published 3GP-DASH (Dynamic Adaptive Streaming over HTTP; 3GPP TS 26.247: ‘Transparent end-to-end packet-switched streaming Service (PSS); Progressive download and dynamic adaptive Streaming over HTTP (3GP-DASH)’. MPEG DASH and 3GP-DASH are technically close to each other and may therefore be collectively referred to as DASH. Streaming systems similar to MPEG-DASH include, for example, HTTP live streaming (a.k.a. HLS), specified in the IETF RFC 8216. For a detailed description of said adaptive streaming system, all providing examples of a video streaming system, wherein the embodiments may be implemented, a reference is made to the above standard documents. It must be note that various embodiments of the invention are not limited to the above standard documents, but rather a description is given for one possible basis on top of which embodiments may be partly or fully realized.

A uniform resource identifier (URI) may be defined as a string of characters used to identify a name of a resource. Such identification enables interaction with representations of the resource over a network, using specific protocols. A URI is defined through a scheme specifying a concrete syntax and associated protocol for the URI. The uniform resource locator (URL) and the uniform resource name (URN) are forms of URI. A URL may be defined as a URI that identifies a web resource and specifies the means of acting upon or obtaining the representation of the resource, specifying both its primary access mechanism and network location. A URN may be defined as a URI that identifies a resource by name in a particular namespace. A URN may be used for identifying a resource without implying its location or how to access it.

In DASH, the multimedia content may be stored on an HTTP server and may be delivered using HTTP. The content may be stored on the server in two parts: media presentation description (MPD), which describes a manifest of the available content, its various alternatives, their URL addresses, and other characteristics; and segments, which include the actual multimedia bitstreams in the form of chunks, in a single or multiple files. The MDP provides the necessary information for clients to establish a dynamic adaptive streaming over HTTP. The MPD includes information describing media presentation, such as an HTTP-uniform resource locator (URL) of each Segment to make GET Segment request. To play the content, the DASH client may obtain the MPD e.g. by using HTTP, email, thumb drive, broadcast, or other transport methods. By parsing the MPD, the DASH client may become aware of the program timing, media-content availability, media types, resolutions, minimum and maximum bandwidths, and the existence of various encoded alternatives of multimedia components, accessibility features and required digital rights management (DRM), media-component locations on the network, and other content characteristics. Using this information, the DASH client may select the appropriate encoded alternative and start streaming the content by fetching the segments using, e.g., HTTP GET requests. After appropriate buffering to allow for network throughput variations, the client may continue fetching the subsequent segments and monitor the network bandwidth fluctuations. The client may decide how to adapt to the available bandwidth by fetching segments of different alternatives (with lower or higher bitrates) to maintain an adequate buffer.

It is to be understood that the usage of DASH is not limited to using HTTP, but DASH may likewise be used with any other communication protocol.

In the context of DASH, the following definitions may be used: a media content component or a media component may be defined as one continuous component of the media content with an assigned media component type that can be encoded individually into a media stream. Media content may be defined as one media content period or a contiguous sequence of media content periods. Media content component type may be defined as a single type of media content such as audio, video, or text. A media stream may be defined as an encoded version of a media content component.

In DASH, a hierarchical data model is used to structure media presentation as follows. A media presentation includes a sequence of one or more periods, each period includes one or more groups, each group includes one or more adaptation sets, each adaptation sets includes one or more representations, each representation includes one or more segments. A group may be defined as a collection of adaptation sets that are not expected to be presented simultaneously. An adaptation set may be defined as a set of interchangeable encoded versions of one or several media content components. A Representation is one of the alternative choices of the media content or a subset thereof typically differing by the encoding choice, e.g., by bitrate, resolution, language, codec, and the like. The segment includes a certain duration of media data, and metadata to decode and present the included media content. A Segment is identified by a URI and can typically be requested by a HTTP GET request. A segment may be defined as a unit of data associated with an HTTP-URL and optionally a byte range that are specified by an MPD.

An initialization segment may be defined as a segment including metadata that is necessary to present the media streams encapsulated in media segments. In ISOBMFF based segment formats, an initialization segment may include the Movie Box (‘moov’) which may not include metadata for any samples, e.g., any metadata for samples is provided in ‘moof’ boxes.

A media segment includes a certain duration of media data for playback at a normal speed, such duration is referred as media segment duration or segment duration. The content producer or service provider may select the segment duration according to the desired characteristics of the service. For example, a relatively short Segment duration may be used in a live service to achieve a short end-to-end latency. The reason is that Segment duration is typically a lower bound on the end-to-end latency perceived by a DASH client since a segment is a discrete unit of generating media data for DASH. Content generation is typically done such a manner that a whole Segment of media data is made available for a server. Furthermore, many client implementations use a segment as the unit for GET requests. Thus, in typical arrangements for live services a segment may be requested by a DASH client when the whole duration of a media segment is available as well as encoded and encapsulated into a segment. For on-demand service, different strategies of selecting segment duration may be used.

A segment may be further partitioned into subsegments, e.g., to enable downloading segments in multiple parts. Subsegments may be required to include complete access units. Subsegments may be indexed by segment index box, which includes information to map presentation time range and byte range for each subsegment. The segment index box may also describe subsegments and stream access points in the segment by signaling their durations and byte offsets. A DASH client may use the information obtained from segment index box(es) to make a HTTP GET request for a specific subsegment using byte range HTTP request. When a relatively long segment duration is used, then subsegments may be used to keep the size of HTTP responses reasonable and flexible for bitrate adaptation. The indexing information of a segment may be put in the single box at the beginning of that segment or spread among many indexing boxes in the segment. Different methods of spreading are possible, such as hierarchical, daisy chain, and hybrid. This technique may avoid adding a large box at the beginning of the segment and therefore may prevent a possible initial download delay.

DASH supports rate adaptation by dynamically requesting Media Segments from different Representations within an adaptation set to match varying network bandwidth. When a DASH client switches up/down representation, coding dependencies within representation have to be taken into account. A representation switch may only happen at a random access point (RAP), which is typically used in video coding techniques such as H.264/AVC. In DASH, a more general concept named SAP is introduced to provide a codec-independent solution for accessing a representation and switching between representations. In DASH, a SAP is specified as a position in a representation that enables playback of a media stream to be started using only the information included in representation data starting from that position onwards (preceded by initializing data in the initialization segment, when present). Hence, representation switching may be performed in SAP.

An end-to-end system for DASH may be described as follows. The media content is provided by an origin server, which may be a conventional web (HTTP) server. The origin server may be connected with a content delivery network (CDN) over which the streamed content is delivered to and stored in edge servers. The MPD allows signaling of multiple base URLs for the content, which can be used to announce the availability of the content in different edge servers. Alternatively, the content server may be directly connected to the Internet. Web proxies may reside on the path of routing the HTTP traffic between the DASH clients and the origin or edge server from which the content is requested. Web proxies cache HTTP messages and hence can serve clients' requests with the cached content. They are commonly used by network service providers, as they reduce the required network bandwidth from the proxy towards origin or edge servers. For end-users HTTP caching provide shorter latency. DASH clients are connected to the Internet through an access network, such as a mobile cellular network. The mobile network may comprise mobile edge servers or mobile edge cloud, operating similarly to a CDN edge server and/or web proxy.

### Fundamentals of Neural Networks

A neural network (NN) is a computation graph consisting of several layers of computation. Each layer consists of one or more units, where each unit performs a computation. A unit is connected to one or more other units, and a connection may be associated with a weight. The weight may be used for scaling the signal passing through an associated connection. Weights are learnable parameters, for example, values which can be learned from training data. There may be other learnable parameters, such as those of batch-normalization layers.

A couple of examples of architectures for neural networks are feed-forward and recurrent architectures. Feed-forward neural networks are such that there is no feedback loop, each layer takes input from one or more of the previous layers, and provides its output as the input for one or more of the subsequent layers. Also, units inside a certain layer take input from units in one or more of preceding layers and provide output to one or more of following layers.

Initial layers, those close to the input data, extract semantically low-level features, for example, edges and textures in images, and intermediate and final layers extract more high-level features. After the feature extraction layers there may be one or more layers performing a certain task, for example, classification, semantic segmentation, object detection, denoising, style transfer, super-resolution, and the like. In recurrent neural networks, there is a feedback loop, so that the neural network becomes stateful, for example, it is able to memorize information or a state.

Neural networks are being utilized in an ever-increasing number of applications for many different types of devices, for example, mobile phones, chat bots, IoT devices, smart cars, voice assistants, and the like. Some of these applications include, but are not limited to, image and video analysis and processing, social media data analysis, device usage data analysis, and the like.

One of the properties of neural networks, and other machine learning tools, is that they are able to learn properties from input data, either in a supervised way or in an unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output error, also referred to as the loss. Examples of losses are mean squared error, cross-entropy, and the like. In recent deep learning techniques, training is an iterative process, where at each iteration the algorithm modifies the weights of the neural network to make a gradual improvement in the network's output, for example, gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, for example, data which was not used for training the model. This is usually referred to as generalization. In practice, data is usually split into at least two sets, the training set and the validation set. The training set is used for training the network, for example, to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following (1-2): 1) when the network is learning at all—in this case, the training set error should decrease, otherwise the model is in the regime of underfitting, 2) when the network is learning to generalize—in this case, also the validation set error needs to decrease and be not too much higher than the training set error. For example, the validation set error should be less than 20% higher than the training set error. If the training set error is low, for example 10% of its value at the beginning of training, or with respect to a threshold that may have been determined based on an evaluation metric, but the validation set error is much higher than the training set error, or it does not decrease, or it even increases, the model is in the regime of overfitting. This means that the model has just memorized properties of the training set and performs well only on that set, but performs poorly on a set not used for training or tuning of its parameters.

Lately, neural networks have been used for compressing and de-compressing data such as images. The most widely used architecture for such task is the auto-encoder, which is a neural network consisting of two parts: a neural encoder and a neural decoder. In various embodiments, these neural encoder and neural decoder would be referred to as encoder and decoder, even though these refer to algorithms which are learned from data instead of being tuned manually. The encoder takes an image as an input and produces a code, to represent the input image, which requires less bits than the input image. This code may have been obtained by a binarization or quantization process after the encoder. The decoder takes in this code and reconstructs the image which was input to the encoder.

Such encoder and decoder are usually trained to minimize a combination of bitrate and distortion, where the distortion may be based on one or more of the following metrics: mean squared error (MSE), peak signal-to-noise ratio (PSNR), structural similarity index measure (SSIM), or the like. These distortion metrics are meant to be correlated to the human visual perception quality, so that minimizing or maximizing one or more of these distortion metrics results into improving the visual quality of the decoded image as perceived by humans.

In various embodiments, terms ‘model’, ‘neural network’, ‘neural net’ and ‘network’ may be used interchangeably, and also the weights of neural networks may be sometimes referred to as learnable parameters or as parameters.

### Generative Artificial Intelligence (AI)

The term generative artificial intelligence (AI), or generative modeling, or generative machine learning (and other similar terms), are commonly used to indicate a class of models learned from data that are capable of generating new data. State-of-the-art generative models are based on neural networks. The basic components or layers of a generative NN are usually not different from the components or layers of a non-generative NN. Example of such components are convolution layers, non-linear layers, fully-connected layers, normalization layers, attention layers, etc.

One typical example of neural network architecture that allows for generating text data is a Transformer-based “decoder”, where “decoder” may not refer to a decoder that is part of a codec performing compression of input data into a small bitstream. Instead, the decoder is a neural network that gets a set of input words or parts of words or tokens extracted from input words, and outputs a set of output words or parts of words or tokens. At inference time, such a NN is run in auto-regressive mode, where the generated word(s) or token(s) is provided as part of the input word(s) or token(s). In order for such a NN to generate data, it is trained to predict the next word(s) (or an estimate of a probability distribution over the next words) given a set of input words. The NN may be based on the Transformer architecture, which comprises the use of the self-attention mechanism, where an attention score is assigned to each input token or word based on all other input tokens or words, including the previously generated words or tokens. During training of a decoder-style Transformer architecture, the future data items (words or tokens) are masked so not to leak information from the future. In some cases, decoder-style Transformer architectures are referred to as “uni-directional”, because they use or process information from left-to-right, as opposed to some encoder-style Transformer architectures that are referred to as “bi-directional” (because they use or process information from left-to-right and from right-to-left).

Another example of generative modeling is visual temporal extrapolation, where a picture is generated by a NN based on one or more previously decoded or generated pictures and on one or more other data items. The one or more previously decoded or generated pictures may be pictures decoded by a process that does not involve generative modeling, such as a traditional codec, e.g., a VVC-compliant codec. The one or more data items may include parameters or features that describe the differences between the one or more previously decoded pictures and the current picture to be temporally extrapolated. Examples of such parameters are facial parameters (such as facial keypoints or facial landmarks and their positions or differential positions with respect to the facial landmarks of a previous picture), or parameters of other objects. The one or more data items may be signaled from encoder to decoder.

An example of an encoder utilizing generative AI may be described as follows: The input base picture is encoded with any video encoding method, such as VVC, into a coded base picture of a bitstream. The input subsequent pictures are fed into the analysis model for extracting feature parameters. The feature parameters are encoded. Feature parameters may be encoded independently of feature parameters of any other picture, e.g., for the first subsequent picture following the base picture in decoding order. Alternatively, feature parameters may be encoded in a predictive manner with reference to earlier encoded feature parameters in decoding order, wherein feature residual may be encoded relative to predicted feature parameters. Feature residual may undergo quantization and entropy coding as part of feature encoding. Encoded feature parameters are included in or along the bitstream, e.g., in a generative face video SEI message.

### Video Coding and Video Metadata Specifications

The Advanced Video Coding standard (which may be abbreviated H.264, AVC or H.264/AVC) was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

The High Efficiency Video Coding standard (which may be abbreviated H.265, HEVC or H.265/HEVC) was developed by the Joint Collaborative Team—Video Coding (JCT-VC) of VCEG and MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC). Extensions to H.265/HEVC include scalable, multiview, three-dimensional, and fidelity range extensions, which may be referred to as SHVC, MV-HEVC, 3D-HEVC, and REXT, respectively. The references in this description to H.265/HEVC, SHVC, MV-HEVC, 3D-HEVC and REXT that have been made for the purpose of understanding definitions, structures or concepts of these standard specifications are to be understood to be references to the latest versions of these standards that were available before the date of this application, unless otherwise indicated.

Versatile Video Coding (which may be abbreviated VVC, H.266, or H.266/VVC) is a video compression standard developed as the successor to HEVC. VVC is specified in ITU-T Recommendation H.266 and equivalently in ISO/IEC 23090-3, which is also referred to as MPEG-I Part 3.

A specification of the AV1 bitstream format and decoding process were developed by the Alliance for Open Media (AOM). The AV1 specification was published in 2018. AOM is reportedly working on the AV2 specification.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams. VUI parameters and SEI messages may, for example, assist in processes related to decoding, display or other purposes.

In another example, the pixel values may be predicted by using spatial prediction techniques. This prediction technique uses the pixel values around the block to be coded in a specified manner. Secondly, the prediction error, for example, the difference between the predicted block of pixels and the original block of pixels is coded. This is typically done by transforming the difference in pixel values using a specified transform, for example, discrete cosine transform (DCT) or a variant of it; quantizing the coefficients; and entropy coding the quantized coefficients. By varying the fidelity of the quantization process, encoder can control the balance between the accuracy of the pixel representation, for example, picture quality and size of the resulting coded video representation, for example, file size or transmission bitrate.

Inter prediction, which may also be referred to as temporal prediction, motion compensation, or motion-compensated prediction, exploits temporal redundancy. In inter prediction the sources of prediction are previously decoded pictures, e.g., reference pictures.

In temporal inter prediction, the sources of prediction are previously decoded pictures in the same scalable layer. In intra block copy (IBC), e.g., intra-block-copy prediction, prediction may be applied similarly to temporal inter prediction but the reference picture is the current picture and only previously decoded samples may be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, for example, either sample values or transform coefficients can be predicted. Intra prediction is typically exploited in intra-coding, where no inter prediction is applied.

One example outcome of the coding procedure is a set of coding parameters, such as motion vectors and quantized transform coefficients. Many parameters can be entropy-coded more efficiently when they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction techniques similar to the encoder to form a predicted representation of the pixel blocks. For example, using the motion or spatial information created by the encoder and stored in the compressed representation and prediction error decoding, which is inverse operation of the prediction error coding recovering the quantized prediction error signal in spatial pixel domain. After applying prediction and prediction error decoding techniques the decoder sums up the prediction and prediction error signals, for example, pixel values to form the output video frame. The decoder and encoder can also apply additional filtering techniques to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded in the encoder side or decoded in the decoder side and the prediction source block in one of the previously coded or decoded pictures.

In order to represent motion vectors efficiently, the motion vectors are typically coded differentially with respect to block specific predicted motion vectors. In typical video codecs, the predicted motion vectors are created in a predefined way, for example, calculating the median of the encoded or decoded motion vectors of the adjacent blocks.

Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or co-located blocks in temporal reference picture.

Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs, the prediction residual after motion compensation is first transformed with a transform kernel, for example, DCT and then coded. The reason for this is that often there still exists some correlation among the residual and transform can in many cases help reduce this correlation and provide more efficient coding.

An out-of-band transmission, signaling, or storage may refer to the capability of transmitting, signaling, or storing information in a manner that associates the information with a video bitstream. The out-of-band transmission may use a more reliable transmission mechanism compared to the protocols used for carrying coded video data, such as slices. The out-of-band transmission, signaling or storage may additionally or alternatively be used, e.g., for ease of access or session negotiation. For example, a sample entry of a track in a file conforming to the ISO Base Media File Format may comprise parameter sets, while the coded data in the bitstream is stored elsewhere in the file or in another file. Another example of out-of-band transmission, signaling, or storage comprises including information, such as NN and/or NN updates in a file format track that is separate from track(s) including coded video data.

The phrase along the bitstream (e.g., indicating along the bitstream) or along a coded unit of a bitstream (e.g., indicating along a coded tile) may be used in claims and described embodiments to refer to transmission, signaling, or storage in a manner that the ‘out-of-band’ data is associated with, but not included within, the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is included in a container file, such as a file conforming to the ISO Base Media File Format, and certain file metadata is stored in the file in a manner that associates the metadata to the bitstream, such as boxes in the sample entry for a track including the bitstream, a sample group for the track including the bitstream, or a timed metadata track associated with the track including the bitstream. In another example, the phrase along the bitstream may be used when the bitstream is made available as a stream over a communication protocol and a media description, such as a streaming manifest, is provided to describe the stream.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of a video encoder and the input of a video decoder, respectively, may be a network abstraction layer (NAL) unit. For transport over packet-oriented networks or storage into structured files, NAL units may be encapsulated into packets or similar structures. A bytestream format encapsulating NAL units may be used for transmission or storage environments that do not provide framing structures. The bytestream format may separate NAL units from each other by attaching a start code in front of each NAL unit. To avoid false detection of NAL unit boundaries, encoders may run a byte-oriented start code emulation prevention algorithm, which may add an emulation prevention byte to the NAL unit payload, when a start code would have occurred otherwise. In order to enable straightforward gateway operation between packet and stream-oriented systems, start code emulation prevention may be performed regardless of whether the bytestream format is in use or not. A NAL unit may be defined as a syntax structure including an indication of the type of data to follow and bytes including that data in the form of a raw byte sequence payload interspersed as necessary with emulation prevention bytes. A raw byte sequence payload (RBSP) may be defined as a syntax structure including an integer number of bytes that is encapsulated in a NAL unit. An RBSP is either empty or has the form of a string of data bits including syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some formats or standards, a first bitstream may be followed by a second bitstream in the same logical channel, such as in the same file or in the same connection of a communication protocol. An elementary stream (in the context of video coding) may be defined as a sequence of one or more bitstreams.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. The NAL unit header indicates the type of the NAL unit. In some coding standards, the NAL unit header indicates a scalability layer identifier (e.g., called nuh_layer_id in H.265/HEVC and H.266/VVC), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as TID, temporal layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

NAL units may be categorized into Video Coding Layer (VCL) NAL units and non-VCL NAL units. VCL NAL units are typically coded slice NAL units.

A non-VCL NAL unit may be, for example, one of the following types: a video parameter set (VPS), a sequence parameter set (SPS), a picture parameter set (PPS), an adaptation parameter set (APS), a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Video coding specifications may enable the use of supplemental enhancement information (SEI) messages or alike. Some video coding specifications include SEI NAL units, and some video coding specifications include both prefix SEI NAL units and suffix SEI NAL units, where the former type may start a picture unit or alike and the latter type may end a picture unit or alike. An SEI NAL unit may include one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient may not be defined. Consequently, encoders may be required to follow the standard specifying a SEI message when they create SEI message(s), and decoders may not be required to process SEI messages for output order conformance. One of the example reasons to include the syntax and semantics of SEI messages in standards is to allow different system specifications to interpret the supplemental information identically and hence interoperate. It is intended that system specifications may require the use of particular SEI messages both in the encoding end and in the decoding end, and additionally the process for handling particular SEI messages in the recipient may be specified.

Some video coding specifications enable metadata OBUs. A metadata OBU comprises a type field, which specifies the type of metadata.

A coded video sequence (CVS) may be defined as a sequence of coded pictures in decoding order that is independently decodable and is followed by another coded video sequence or the end of the bitstream.

A coded layer video sequence (CLVS) may be defined as a sequence of pictures and associated other data within the same scalable layer (e.g., with the same value of nuh_layer_id in VVC) that is decodable independently of other pictures in the same layer.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance. The variable including a POC value of a picture may be referred to as PicOrderCntVal.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de)coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have _idc postfix in its name.

Images may be split into independently codable and decodable image segments (e.g., slices or tiles or tile groups). Such image segments may enable parallel processing. Image segments may be coded as separate units in the bitstream, such as VCL NAL units in H.264/AVC, HEVC, and VVC. Coded image segments may comprise a header and a payload, wherein the header includes parameter values needed for decoding the payload.

In some video coding formats, such as HEVC and VVC, a picture is divided into one or more tile rows and one or more tile columns. A tile is a sequence of coding tree units (CTU) that covers a rectangular region of a picture. The partitioning to tiles forms a grid that may be characterized by a list of tile column widths (in CTUs) and a list of tile row heights (in CTUs). For encoding and/or decoding, the CTUs in a tile are scanned in raster scan order within that tile. In HEVC, tiles are ordered in the bitstream consecutively in the raster scan order of the tile grid.

In some video coding formats, such as AV1, a picture may be partitioned into tiles, and a tile consists of an integer number of complete superblocks that collectively form a complete rectangular region of a picture. In-picture prediction across tile boundaries may be disabled. The minimum tile size may be one superblock, and the maximum tile size in the presently specified levels in AV1 is 4096×2304 in terms of luma sample count. The picture is partitioned into a tile grid of one or more tile rows and one or more tile columns. The tile grid may be signaled in the picture header to have a uniform tile size or nonuniform tile size, where in the latter case the tile row heights and tile column widths are signaled. The superblocks in a tile are scanned in raster scan order within that tile.

In some video coding formats, such as VVC, a slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which includes an integer number of consecutive complete CTU rows within the tile.

In some video coding formats, such as VVC, two modes of slices are supported, namely the raster-scan slice mode and the rectangular slice mode. In the raster-scan slice mode, a slice includes a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

In HEVC, a slice consists of an integer number of CTUs. The CTUs are scanned in the raster scan order of CTUs within tiles or within a picture when tiles are not in use. A slice may include an integer number of tiles, or a slice can be contained in a tile.

In some video coding formats, such as AV1, a tile group OBU carries one or more complete tiles. The first and last tiles of in the tile group OBU may be indicated in the tile group OBU before the coded tile data. Tiles within a tile group OBU may appear in a tile raster scan of a picture.

In some video coding formats, such as VVC, a subpicture may be defined as a rectangular region of one or more slices within a picture, wherein the one or more slices are complete. Thus, a subpicture includes one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices. One or both of the following conditions may be required to be fulfilled for each subpicture and tile: i) all CTUs in a subpicture belong to the same tile; ii) All CTUs in a tile belong to the same subpicture.

One or both of the following conditions may be required to be fulfilled for each subpicture and tile: i) All CTUs in a subpicture belong to the same tile. ii) All CTUs in a tile belong to the same subpicture.

An independent VVC subpicture is treated like a picture in the VVC decoding process. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A motion-constrained tile set (MCTS) is such that the inter prediction process is constrained in encoding such that no sample value outside the motion-constrained tile set, and no sample value at a fractional sample position that is derived using one or more sample values outside the motion-constrained tile set, is used for inter prediction of any sample within the motion-constrained tile set. Additionally, the encoding of an MCTS is constrained in a manner that motion vector candidates are not derived from blocks outside the MCTS. This may be enforced by turning off temporal motion vector prediction (TMVP), where TMVP may be specified like in HEVC, for example, or by disallowing the encoder to use the TMVP candidate or any motion vector prediction candidate following the TMVP candidate in a motion vector prediction list, such as the merge or AMVP candidate list as specified in HEVC, for prediction unit located directly left of the right tile boundary of the MCTS except the last one at the bottom right of the MCTS. In general, an MCTS may be defined to be a tile set that is independent of any sample values and coded data, such as motion vectors, that are outside the MCTS. In some cases, an MCTS may be required to form a rectangular area. It should be understood that depending on the context, an MCTS may refer to the tile set within a picture or to the respective tile set in a sequence of pictures. The respective tile set may be, but in general need not be, collocated in the sequence of pictures.

### Encoder Optimization Information (EOI) SEI Message

The encoder optimization information (EOI) SEI message has been included in a draft of VSEI version 4. The EOI SEI message is used to indicate if the video has been optimized for human viewing or machine analysis and which types of optimization have been applied in pre-processing or encoding.

The syntax of EOI SEI message may be described as follows:

| | Descriptor |
|---|---|
| encoder_optimization_info(payloadSize ) { | |
| eoi_cancel_flag | u(1) |
| if( !eoi_cancel_flag ) { | |
| eoi_persistence_flag | u(1) |
| eoi_for_human_viewing_idc | u(2) |
| eoi_for_machine_analysis_idc | u(2) |
| eoi_for_model_training_idc | u(2) |
| eoi_type | u(16) |
| if( EoiObjectBasedFlag ) | |
| eoi_object_based_idc | ue(v) |
| if( EoiTemporalResamplingFlag ) { | |
| eoi_temporal_resampling_type_flag | u(1) |
| eoi_num_int_pics | ue(v) |
| } | |
| } | |
| } | |

eoi_cancel_flag equal to 1 specifies that the persistence of the encoder optimization information SEI message included in any previous PU in output order is cancelled. eoi_cancel_flag equal to 0 indicates that information on optimization that has been applied in pre-processing or encoding follows.
eoi_persistence_flag specifies the persistence of the optimization information provided in this SEI message. eoi_persistence_flag equal to 0 specifies that the optimization information applies for the current picture only. eoi_persistence_flag equal to 1 specifies that the optimization information applies for the current picture and all subsequent pictures of the current layer in output order until one or more of the following conditions are true (1-3): 1) A new CLVS of the current layer begins, 2) The bitstream ends, 3) A picture in the current layer associated with an encoder optimization information SEI message is output that follows the current picture in output order.
eoi_for_human_viewing_idc equal to 3 specifies that purposes for the applied optimization include human viewing. eoi_for_human_viewing_idc equal to 2 specifies that the video is suitable but not specifically optimized for human viewing. eoi_for_human_viewing_idc equal to 1 specifies that the video is unsuitable for human viewing. eoi_for_human_viewing_idc equal to 0 specifies that it is unknown if the video is suitable for human viewing.
eoi_for_machine_analysis_idc equal to 3 specifies that purposes for the applied optimization include machine analysis. eoi_for_machine_analysis_idc equal to 2 specifies that the video is suitable but not specifically optimized for machine analysis. eoi_for_machine_analysis_idc equal to 1 specifies that the video is unsuitable for machine analysis. eoi_for_machine_analysis_idc equal to 0 specifies that it is unknown if the video is suitable for machine analysis.
eoi_type indicates the types of optimization method as a bit mask where (eoi_type & bitMask) not equal to 0 indicates that the optimization type with a particular bitMask value has been applied. When eoi_type is greater than 0 and (eoi_type & bitMask) is equal to 0, the optimization type with the particular bitMask value has not been applied. When eoi_type is equal to 0, optimization as determined by the application has been used. bitmask values may be defined, for example, as follows:

| bitMask | Interpretation |
|---|---|
| 0x01 | Object-based optimization; the pictures for |
| | which this SEI message persists have been |
| | pre-processed or encoded so that detected |
| | objects in the pictures are optimized with |
| | respect to other parts of the pictures for the |
| | indicated optimization purposes |
| 0x02 | Temporal resampling optimization |
| 0x04 | Spatial resampling optimization |
| 0x08 | Temporal quality optimization in a manner |
| | that quality fluctuates temporally |
| 0x10 | Spatial quality optimization; the pictures |
| | for which this SEI message persists have |
| | been pre-processed or encoded to reduce |
| | unnecessary information or improve the |
| | quality of necessary information.(e.g. to |
| | reduce the amount of noise and remove |
| | speckles at the picture-level) |

The remaining syntax elements within the EOI SET message may provide further characterization of the applied optimizations.

It may be possible to implement syntax and semantics for an SET message addressing the purpose of marking one or more coded pictures as created or modified by generative AI. However, as the intent of this syntax and semantics is to merely identify so called “fake” videos, this syntax and semantics does not address the problems addressed by the examples described herein.

Commonly AI models and inference engines used in computer vision tasks make use of images/video frames for training. However, in certain scenarios the content provider or the subject in the scene do not wish to be part of such applications (for example protecting the privacy of a person without blurring the face in photos/videos). One other reason could be copyright infringement, so that the content owner would not want its media to be used for training AI models.

With the rise of the AT, there are a number of algorithms that allow to create ‘poisoned data’ for making an image unusable for AI models, but at the same time usable for an end user, is growing.

The algorithms can be used by content creators to protect their work from being used by the AI models. At the same time, it can be assumed that those content creators do not have bad intentions. However, the images with the additional ‘poisoned data’ can be harmful for the AI models and significantly reduce their accuracy and performance. Especially when an AI model is used for a mission-critical task, such as detecting pedestrians on the road or detecting certain objects in an area, avoiding AI poisoning is a must.

But how does an AI expert know that the image/video dataset that is used does not contain such AI-poisoned image/video samples?

Poisoned data can be any signal processing operation/method performed on the image/video frame without any external data or any external data (for example a mask) used together with a signal processing operation/method performed on the image/video frame such that the resulting image/video frame is unusable for training or consumption for AI models, but at the same time usable for a specific application/use case or viewing purposes.

It is important to provide signaling information in or along a video/image bitstream that the content creator used image altering algorithm that make the picture(s) unusable for (1-2): 1) training of AI models, i.e., the picture makes a harmful effect on the training of AI models; and/or 2) input to an inference of an AI model. The signaling information may interchangeably be referred to as AI usability information. The signaling information may be present in a video/image bitstream, for example in a SEI message, and/or in a file format and/or in a media description, such DASH MPD.

It is to be understood that while some embodiments are described in relation to signaling information for a picture, the embodiments generally apply to the inferred or indicated scope. The scope may, for example, be a spatial scope, temporal scope, or a spatio-temporal scope. A spatial scope may, for example, comprise a rectangular region within the picture. A temporal scope may, for example, comprise a sequence of one or more pictures. A spatio-temporal scope may, for example, comprise a rectangular region within a sequence of one or more pictures. The scope may, for example, be inferred from a structure that comprises the signaling information. For example, when the structure that comprises the signaling information concerns the entire video bitstream, the scope may be inferred to comprise all the pictures of the video bitstream. For example, when the signaling information is included in the Representation level of DASH MPD, the scope may be inferred to comprise all the pictures of the Representation. In another example, when the signaling information is included in a sample entry of a track of an ISO base media file, the scope may be inferred to comprise all the samples that refer to the sample entry. Alternatively, the scope may be indicated, for example in or along the signaling information. For example, the scope may be indicated to persist to the picture associated with the signaling information and all subsequent pictures, e.g., in output order, until it is cancelled or replaced by another signaling information.

It is to be understood that embodiments may likewise be realized with a finer-grained information indicative of to what extent the picture is usable for training of AI models and/or input to AI model inference. For example, the finer-grained information may be indicative of the following or any subset thereof (1-5): 1) The picture has been preprocessed or encoded to be optimized for training of AI models and/or input to AI model inference, 2) The picture is suitable for training of AI models and/or input to AI model inference, 3) The picture may be unsuitable for training of AI models and/or input to AI model inference, 4) The picture is unusable for training of AI models and/or input to AI model inference, 5) It is unknown if the picture to what extent the picture is usable for training of AI models and/or input to AI model inference.

It is to be understood that embodiments may likewise be realized using different or additional characterization, such as harmful, disadvantageous or suboptimal, rather than or in addition to “unsuitable” when describing the suitability of the picture for training of AI models and/or input to AI model inference. Likewise, it is to be understood that embodiments may likewise be realized using different or additional characterization, such as harmless or advantageous, rather than or in addition to “suitable” when describing the suitability of the picture for training of AI models and/or input to AI model inference. Embodiments are not limited to specific characterizations.

Additionally, the signaling information may comprise characterization of AI models that the signaling information concerns. For example, the AI model may be characterized to be any of the following (1-4): 1) Computer vision task, such as object detection, instance segmentation, object tracking. For example, the video/image in the scope of the signaling may have been modified to make objects unrecognizable and hence the video/image is not suitable for training a neural network for object detection or object recognition, 2) End-to-end compression neural network. For example, the video/image in the scope of the signaling may have degraded picture quality (e.g. blocking, ringing, or other conventional compression artefacts) and hence may cause the end-to-end compression neural network to learn to reproduce similar degraded picture quality, 3) View synthesis model, which generates a novel view based on input picture(s) and potential other data, 4) Generative artificial intelligence model.

In one embodiment, an AIUsabilityBox box describing AI information is defined.

```
class AIUsabilityBox extends Box(‘aiuc’) {
  unsigned int(1) valid_for_training;
  unsigned int(1) valid_for_computer_vision;
  unsigned int(1) valid_for_neural_network_transcoding;
  unsigned int(1) valid_for_inference;
  unsigned int(4) reserved;
}
```

valid_for_training equal to 1 indicates that the item/track can be used for training AI models, equal to 0 indicates that an algorithm may be applied on the item/track making it unusable (harmful) for the AI models.
valid_for_computer_vision equal to 1 indicates that the item/track can be used for computer vision tasks.
valid_for_neural_network_transcoding equal to 1 indicates that the item/track can be transcoded using neural networks.
valid_for_inference equal to 1 indicates that the item/track can be processed with trained neural network.

In one embodiment, AIUsabilityBox is an item property and can be attached to an image item it describes.

In one embodiment, MetaBox may contain AIUsabilityBox. In that case, the information would apply for the whole file, or alternatively to all the image items of the file.

aligned(8) class MetaBox (handler_type)
extends FullBox(‘meta’, version = 0, 0) {

| | | |
|---|---|---|
| HandlerBox(handler_type) | theHandler; | |
| PrimaryItemBox | primary_resource; | // optional |
| DataInformationBox | file_locations; | // optional |
| ItemLocationBox | item_locations; | // optional |
| ItemProtectionBox | protections; | // optional |
| ItemInfoBox | item_infos; | // optional |
| IPMPControlBox | IPMP_control; | // optional |
| ItemReferenceBox | item_refs; | // optional |
| ItemDataBox | item_data; | // optional |
| AIUsabilityBox | ai_usability | // optional |
| Box | other_boxes[ ]; | // optional |

}

In an alternate embodiment, AIUsabilityBox present inside a MetaBox indicates AI usability information of a subset of items represented by the MetaBox.

In an example embodiment, the AIUsabilityBox box describing AI information of a subset of items represented by the MetaBox is defined as follows.

```
class AIUsabilityBox extends Box(‘aiuc’) {
  unsigned int(32) item_count;
  for(i=0; i<item_count; i++){
    unsigned int(32) item_ID;
      unsigned int(1) valid_for_training;
      unsigned int(1) valid_for_computer_vision;
      unsigned int(1) valid_for_neural_network_transcoding;
      unsigned int(1) valid_for_inference;
      unsigned int(4) reserved;
    }
    }
```

Item_count indicates the number of items for which the AI usability information is present
Item_ID indicates the specific item with a ID equal to item_ID for which the AI usability information is present.

In one embodiment, AI usability information of a track may be included in a syntax structure (e.g. AIUsabilityBox) in track level, e.g., as a child box of TrackBox, as a child box of MediaBox, or as a child box of a sample entry (SampleEntry).

In one embodiment, a new SchemeTypeBox and/or a SchemeInformationBox may be defined, which will signal the protection scheme related information:

```
aligned(8) class ItemProtectionBox
    extends FullBox(‘ipro’, version = 0, 0) {
  unsigned int(16) protection_count;
  for (i=1; i<=protection_count; i++) {
    ProtectionSchemeInfoBox protection_information;
  }
}
aligned(8) class ProtectionSchemeInfoBox(fmt)
    extends Box(‘sinf’) {
  OriginalFormatBox(fmt) original_format;
    // mandatory for sample protection,
    // shall not be present for item protection
  SchemeTypeBox scheme_type_box; // optional
  SchemeInformationBox info; // optional
}
aligned(8) class OriginalFormatBox(codingname)
    extends Box (‘frma’) {
  unsigned int(32) data_format = codingname;
}
aligned(8) class SchemeTypeBox
    extends FullBox(‘schm’, 0, flags) {
  unsigned int(32) scheme_type; // 4CC identifying the scheme
  unsigned int(32) scheme_version; // scheme version
  if (flags & 0x000001) {
    utf8string scheme_uri; // browser uri
  }
}
aligned(8) class SchemeInformationBox extends Box(‘schi’) {
  Box scheme_specific_data[ ];
}
```

In the embodiment where a new SchemeTypeBox and/or a SchemeInformationBox may be defined (1-6):
1. data_format of the OriginalFormatBox may be defined by a specific 4CC code that indicates AI protected content. ‘aipc’ could be an example for such a 4CC code.
2. scheme_type of the SchemeTypeBox may contain the 4CC code of AI protection scheme. ‘aips’ could be an example of such a 4CC code.
3. scheme_specific_data[ ] may be empty or contain additional information of the application that did the AI protection. ‘nightshade’ or ‘glaze’ could be examples.
4. scheme_version may contain the version of the protection scheme
5. scheme_uri may contain a URI that contains information about the AI protection or a message or be displayed for informative purposes.
6. item_protection_index of ItemInfoEntry box may then signal the correct protection index that maps to the AI protection scheme information.

It may be so that any of these fields may contain a specific 4CC code or value that indicate AI protection information.

In one embodiment, the extended_meta payload within the MinimizedImageBox may contain AIUsabilityBox with the following restrictions: it shall have no AIUsabilityBox entries for items 1 to 16.

In one embodiment, the expanded MetaBox shall have an ItemPropertiesBox containing an ItemPropertyContainerBox and an ItemPropertyAssociationBox. The ItemPropertyContainerBox shall have 16 entries. Where one of the entries include the AI_usability information.

In one embodiment, the extended_meta payload within the MinimizedImageBox may one of those flags:
valid_for_training equal to 1 indicates that the item/track can be used for training AI models, equal to 0 indicates that an algorithm may be applied on the item/track making it unusable (harmful) for the AI models.
valid_for_computer_vision equal to 1 indicates that the item/track can be used for computer vision tasks.
valid_for_neural_network_transcoding equal to 1 indicates that the item/track can be transcoded using neural networks.
valid_for_inference equal to 1 indicates that the item/track can be processed with trained neural network.

In one embodiment, AI usability information of a video bitstream may be included in a supplemental enhancement information (SEI) message in or along the bitstream.

In an embodiment, the encoder optimization information (EOI) SEI message (undergoing standardization in VSEI v4) may be defined to indicate AI usability information.

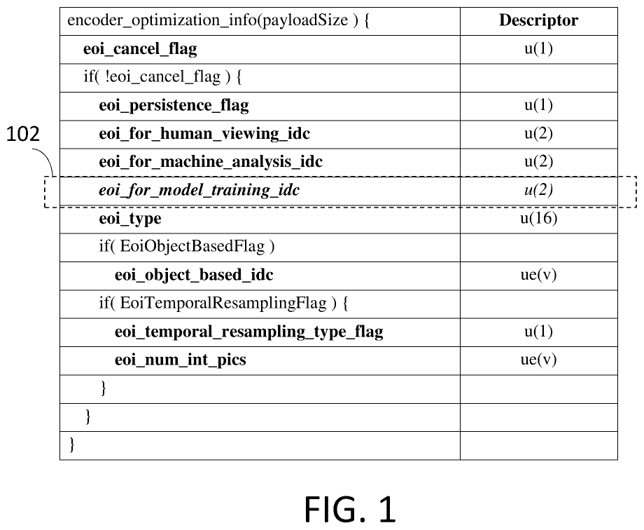

In an embodiment, a syntax element indicating to what extent the decoded pictures within the scope of the EOI SEI message are suitable for training of AI models is included in the EOI SEI message. An example of such syntax element is eoi_for_model_training_idc below and shown in FIG. 1.

| | Descriptor |
|---|---|
| encoder_optimization_info(payloadSize ) { | |
| eoi_cancel_flag | u(1) |
| if( !eoi_cancel_flag ) { | |
| eoi_persistence_flag | u(1) |
| eoi_for_human_viewing_idc | u(2) |
| eoi_for_machine_analysis_idc | u(2) |
| eoi_for_model_training_idc | u(2) |
| eoi_type | u(16) |
| if( EoiObjectBasedFlag ) | |
| eoi_object_based_idc | ue(v) |
| if( EoiTemporalResamplingFlag ) { | |
| eoi_temporal_resampling_type_flag | u(1) |
| eoi_num_int_pics | ue(v) |
| } | |
| } | |
| } | |

eoi_for_model_training_idc (item 102 in FIG. 1) equal to 3 specifies that the video has been optimized to be used for training artificial intelligence models. eoi_for_human_viewing_idc equal to 2 specifies that the video is suitable but not specifically optimized to be used for training artificial intelligence models. eoi_for_human_viewing_idc equal to 1 specifies that the video is unsuitable for training artificial intelligence models. eoi_for_human_viewing_idc equal to 0 specifies that it is unknown if the video is suitable for training artificial intelligence models.

In an embodiment, an optimization type for the encoder optimization information (EOI) SEI message (undergoing standardization in VSEI v4) may be defined to indicate AI usability information.

In an embodiment, an optimization type bit of eoi_type of the EOI SEI message, when equal to 1, is defined to be indicative that the video has been preprocessed or encoded so that it is unsuitable for training artificial intelligence models.

In an embodiment, when it is indicated in an EOI SEI message that the video has been optimized or is suitable or is unsuitable to be used for training AI models, the EOI SEI message also comprises characterization of the AI models that the optimization information concerns.

In one embodiment, AI usability information descriptor of a Representation/Adaptation Set may be included at the MPD level or at a Period level or at Preselection Level or at Adaptation Level or at Representation level or at Sub-Representation level. The AI usability information descriptor contains child elements that indicate the usability of the image/video frames for different tasks.

The embodiments may be relevant to ISO/IEC 14496-12 (ISOBMFF) or ISO/IEC 23008-12 (HEIF) for MPEG.

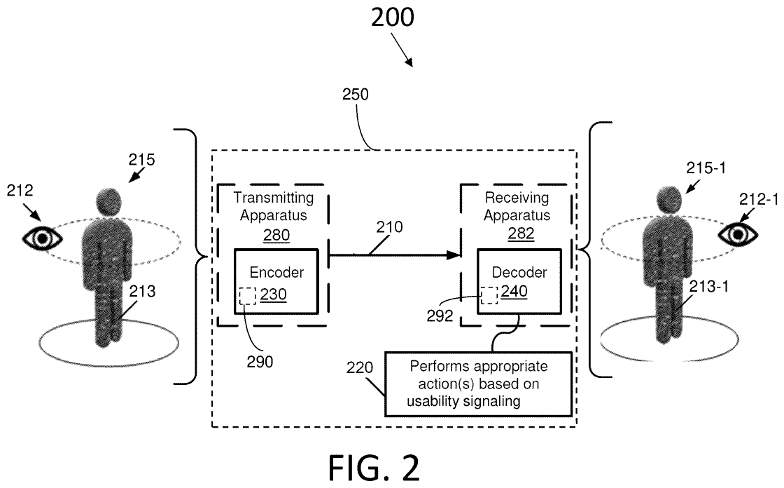

FIG. 2 is a block diagram illustrating a system 200 in accordance with several examples. In an example, the encoder 230 is used to encode an image or video from the scene 215, and the encoder 230 is implemented in a transmitting apparatus 280. The encoder 230 produces a bitstream 210 comprising signaling that is received by the receiving apparatus 282, which implements a decoder 240. The encoder 230 sends the bitstream 210 that comprises the herein described signaling. The decoder 240 forms the image or video for the scene 215-1, and the receiving apparatus 282 would present this to the user, e.g., via a smartphone, television, or projector among many other options.

In some examples, the transmitting apparatus 280 and the receiving apparatus 282 are at least partially within a common apparatus, and for example are located within a common housing 250. In other examples the transmitting apparatus 280 and the receiving apparatus 282 are at least partially not within a common apparatus and have at least partially different housings. Therefore in some examples, the encoder 230 and the decoder 240 are at least partially within a common apparatus, and for example are located within a common housing 250. For example the common apparatus comprising the encoder 230 and decoder 240 implements a codec. In other examples the encoder 230 and the decoder 240 are at least partially not within a common apparatus and have at least partially different housings, but when together still implement a codec.

In some examples, 3D media from the capture (e.g., volumetric capture) at a viewpoint 212 of the scene 215, which includes a person 213) is converted via projection to a series of 2D representations with occupancy, geometry, and attributes. Additional atlas information is also included in the bitstream to enable inverse reconstruction. For decoding, the received bitstream 210 is separated into its components with atlas information; occupancy, geometry, and attribute 2D representations. A 3D reconstruction is performed to reconstruct the scene 215-1 created looking at the viewpoint 212-1 with a “reconstructed” person 213-1. The “−1” are used to indicate that these are reconstructions of the original. As indicated at 220, the decoder 240 performs an action or actions based on the received usability signaling.

In another example, usability encoding 290 performs encoding of signaling of media usability for artificial intelligence models as described herein, and usability decoding 292 performs decoding of the signaling of media usability for artificial intelligence models. The receiving apparatus 282 may implement an artificial intelligence model using the image (e.g. person 213) from the scene 215 when the signaling within the bitstream 210 indicates that the image 213 is usable or suitable for use with the artificial intelligence model. The receiving apparatus 282 may implement the artificial intelligence model without using the image 213 when the signaling within the bitstream 210 indicates that image 213 is unusable or unsuitable for use with the artificial intelligence model.

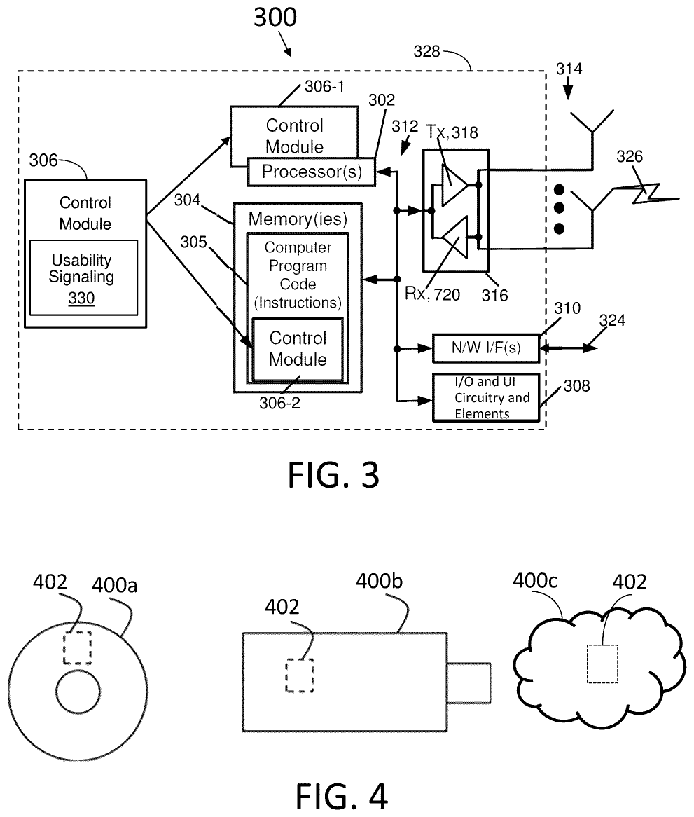

FIG. 3 is an example apparatus 300, which may be implemented in hardware, configured to implement the examples described herein. The apparatus 300 comprises at least one processor 302 (e.g., an FPGA and/or CPU), one or more memories 304 including computer program code 305, the computer program code 305 having instructions to carry out the methods described herein, wherein the at least one memory 304 and the computer program code 305 are configured to, with the at least one processor 302, cause the apparatus 300 to implement circuitry, a process, component, module, or function (implemented with control module 306) to implement the examples described herein.

Usability signaling 330 of the control module 306 implements the embodiments described herein related to signaling (e.g. forming the signaling and determining usability information from the signaling, or encoding or decoding such signaling) media usability for artificial intelligence models such as neural networks. The memory 304 may be a non-transitory memory, a transitory memory, a volatile memory (e.g. RAM), or a non-volatile memory (e.g., ROM).

The apparatus 300 includes a display and/or I/O interface 308, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 300 includes one or more communication e.g. network (N/W) interfaces (I/F(s)) 310. The communication I/F(s) 310 may be wired and/or wireless and communicate over the Internet/other network(s) via any communication technique including via one or more links 324. The communication I/F(s) 310 may comprise one or more transmitters or one or more receivers.

The transceiver 316 comprises one or more transmitters 318 and one or more receivers 320. The transceiver 316 and/or communication I/F(s) 310 may comprise standard well-known components such as an amplifier, filter, frequency-converter, (de)modulator, and encoder/decoder circuitries and one or more antennas, such as antennas 314 used for communication over wireless link 326.

The control module 306 of the apparatus 300 comprises one of or both parts 306-1 and/or 306-2, which may be implemented in a number of ways. The control module 306 may be implemented in hardware as control module 306-1, such as being implemented as part of the one or more processors 302. The control module 306-1 may be implemented also as an integrated circuit or through other hardware such as a programmable gate array. In another example, the control module 306 may be implemented as control module 306-2, which is implemented as computer program code (having corresponding instructions) 305 and is executed by the one or more processors 302. For instance, the one or more memories 304 store instructions that, when executed by the one or more processors 302, cause the apparatus 300 to perform one or more of the operations as described herein. Furthermore, the one or more processors 302, one or more memories 304, and example algorithms (e.g., as flowcharts and/or signaling diagrams), encoded as instructions, programs, or code, are means for causing performance of the operations described herein.

The apparatus 300 to implement the functionality of control 306 may correspond to any of the apparatuses depicted herein. Alternatively, apparatus 300 and its elements may not correspond to any of the other apparatuses depicted herein, as apparatus 300 may be part of a self-organizing/optimizing network (SON) node or other node, such as a node in a cloud.

The apparatus 300 may also be distributed throughout the network including within and between apparatus 300 and any network element (such as a base station and/or terminal device and/or user equipment).

Interface 312 enables data communication and signaling between the various items of apparatus 300, as shown in FIG. 3. For example, the interface 312 may be one or more buses such as address, data, or control buses, and may include any interconnection mechanism, such as a series of lines on a motherboard or integrated circuit, fiber optics or other optical communication equipment, and the like. Computer program code (e.g. instructions) 305, including control 306 may comprise object-oriented software configured to pass data or messages between objects within computer program code 305. Computer program code (e.g. instructions) 305, including control 306 may comprise procedural, functional, or scripting code. The apparatus 300 need not comprise each of the features mentioned, or may comprise other features as well. The various components of apparatus 300 may at least partially reside in a common housing 328, or a subset of the various components of apparatus 300 may at least partially be located in different housings, which different housings may include housing 328.

FIG. 4 shows a schematic representation of non-volatile memory media 400a (e.g. computer/compact disc (CD) or digital versatile disc (DVD)) and 400b (e.g. universal serial bus (USB) memory stick) and 400c (e.g. cloud storage for downloading instructions and/or parameters 402 or receiving emailed instructions and/or parameters 402) storing instructions and/or parameters 402 which when executed by a processor allows the processor to perform one or more of the operations of the methods described herein. Instructions and/or parameters 402 may represent or correspond to a non-transitory computer readable medium.

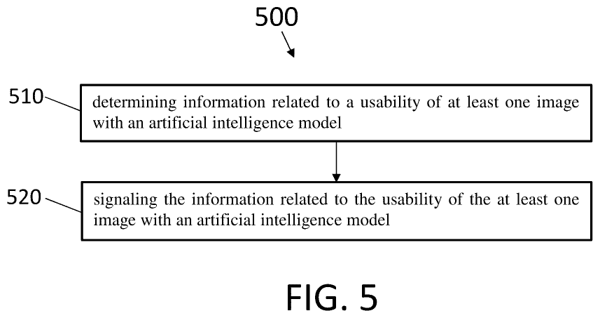

FIG. 5 is an example method 500, based on the examples described herein. At 510, the method includes determining information related to a usability of at least one image with an artificial intelligence model. At 520, the method includes signaling the information related to the usability of the at least one image with an artificial intelligence model. Method 500 may be performed with transmitting apparatus 280 or apparatus 300.

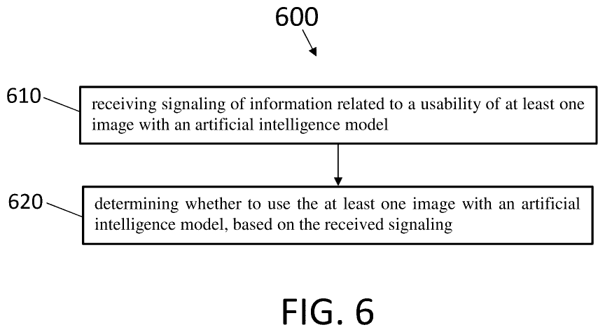

FIG. 6 is an example method 600, based on the examples described herein. At 610, the method includes determining information related to a usability of at least one image with an artificial intelligence model. At 620, the method includes signaling the information related to the usability of the at least one image with an artificial intelligence model. Method 600 may be performed with receiving apparatus 282 or apparatus 300.

The following examples are provided and described herein.

Example 1. An apparatus including: at least one processor; and at least one memory storing instructions that, when executed by the at least one processor, cause the apparatus at least to: determine information related to a usability of at least one image with an artificial intelligence model; and signal the information related to the usability of the at least one image with an artificial intelligence model.

Example 2. The apparatus of example 1, wherein the usability of the at least one image indicates an extent to which the at least one image is usable with an artificial intelligence model, unusable with an artificial intelligence model, suitable for use with an artificial intelligence model, or unsuitable for use with an artificial intelligence model.

Example 3. The apparatus of any of examples 1 to 2, wherein the artificial intelligence model is a statistical model.

Example 4. The apparatus of any of examples 1 to 3, wherein the signaled information indicates that the at least one image was altered using a process that makes the at least one image unsuitable or unusable for training an artificial intelligence model or as input to an artificial intelligence model for inference.

Example 5. The apparatus of any of examples 1 to 4, wherein the signaled information indicates that the at least one image has been encoded in a way that makes the at least one image usable or suitable for training an artificial intelligence model or as input to an artificial intelligence model for inference.

Example 6. The apparatus of any of examples 1 to 5, wherein the signaled information indicates to what extent the at least one image is usable, suitable, unusable, or unsuitable for training an artificial intelligence model or as input to an artificial intelligence model for inference.

Example 7. The apparatus of any of examples 1 to 6, wherein the signaled information indicates that the extent to which the at least one image is usable, suitable, unusable, or unsuitable for training an artificial intelligence model or as input to an artificial intelligence model for inference is unknown.

Example 8. The apparatus of any of examples 1 to 7, wherein the artificial intelligence model for which the information related to the usability of the at least one image with an artificial intelligence model is signaled comprises one of: a computer vision task, wherein the computer vision task comprises object detection, instance segmentation, or object tracking, or an end-to-end compression neural network, or a view synthesis model, or a generative artificial intelligence model.

Example 9. The apparatus of any of examples 1 to 8, wherein the instructions, when executed by the at least one processor, cause the apparatus at least to: store the information related to the usability of the at least one image with an artificial intelligence model within an artificial intelligence usability box syntax element.

Example 10. The apparatus of example 9, wherein the artificial intelligence usability box syntax element comprises at least one one-bit indication that indicates to what extent the at least one image is usable or unusable with an artificial intelligence model.

Example 11. The apparatus of any of examples 9 to 10, wherein the artificial intelligence usability box syntax element comprises at least one or more of: a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image, making the item or track unusable or harmful for an artificial intelligence model, or a valid for computer vision flag, wherein a value for the valid for computer vision flag being equal to 1 indicates that the item or track associated with the at least one image can be used for computer vision tasks, or a valid for neural network transcoding flag, wherein a value for the valid for neural network transcoding flag being equal to 1 indicates that the item or track associated with the at least one image can be transcoded using neural networks, or a valid for inference flag, wherein a value for the valid for inference flag being equal to 1 indicates that the item or track associated with the at least one image can be processed with a trained neural network.

Example 12. The apparatus of any of examples 9 to 11, wherein the artificial intelligence usability box syntax element is an item property that can be attached to an image item associated with the at least one image, wherein the item property describes the image item.

Example 13. The apparatus of any of examples 9 to 12, wherein the instructions, when executed by the at least one processor, cause the apparatus at least to: store the artificial intelligence usability box syntax element within a metabox syntax element; wherein the metabox syntax element describes a file, and the information related to the usability of the at least one image with an artificial intelligence model is applicable to the file.

Example 14. The apparatus of example 13, wherein the metabox syntax element comprises an item properties box containing an item property container box, and the item property container box comprises 16 entries, wherein one of the 16 entries includes the information related to the usability of the at least one image with an artificial intelligence model.

Example 15. The apparatus of any of examples 1 to 14, wherein the instructions, when executed by the at least one processor, cause the apparatus at least to: store the information related to the usability of the at least one image with an artificial intelligence model within a track level syntax structure, wherein the track level syntax structure is a child box of a track box syntax element, a media box syntax element, or a sample entry.

Example 16. The apparatus of any of examples 1 to 15, wherein the instructions, when executed by the at least one processor, cause the apparatus at least to: store the information related to the usability of the at least one image with an artificial intelligence model within a scheme information syntax element; wherein the scheme information syntax element indicates: a scheme used to protect the at least one image from an artificial intelligence model, or that the at least one image is protected from an artificial intelligence model.

Example 17. The apparatus of any of examples 1 to 16, wherein the instructions, when executed by the at least one processor, cause the apparatus at least to: store the information related to the usability of the at least one image with an artificial intelligence model within an artificial intelligence usability box, wherein an extended meta payload within a minimized image box contains the artificial intelligence usability box, wherein the extended meta payload has no artificial intelligence usability box entries for items 1 to 16 of the extended meta payload.

Example 18. The apparatus of any of examples 1 to 17, wherein the instructions, when executed by the at least one processor, cause the apparatus at least to: store the information related to the usability of the at least one image with an artificial intelligence model within an extended meta payload, wherein the extended meta payload is within a minimized image box.

Example 19. The apparatus of example 18, wherein the extended meta payload comprises at least one or more of: a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image making the item or track unusable or harmful for artificial intelligence model, or a valid for computer vision flag, wherein a value for the valid for computer vision flag being equal to 1 indicates that the item or track associated with the at least one image can be used for computer vision tasks, or a valid for neural network transcoding flag, wherein a value for the valid for neural network transcoding being equal to 1 indicates that the item or track associated with the at least one image can be transcoded using neural networks, or a valid for inference flag wherein a value for the valid for inference flag being equal to 1 indicates that the item or track associated with the at least one image can be processed with a trained neural network.

Example 20. The apparatus of any of examples 1 to 19, wherein the instructions, when executed by the at least one processor, cause the apparatus at least to: store the information related to the usability of the at least one image with an artificial intelligence model as a descriptor within a representation or adaptation set, wherein the representation or adaptation set is within a media presentation description.

Example 21. The apparatus of example 20, wherein the media presentation description is defined based on ISO/IEC 23009-1 (DASH).

Example 22. The apparatus of any of examples 1 to 21, wherein the instructions, when executed by the at least one processor, cause the apparatus at least to store the information related to the usability of the at least one image with an artificial intelligence model within at least one or more of: a supplemental enhancement information message, or an encoder optimization information supplemental enhancement information message.

Example 23. The apparatus of any of examples 1 to 22, wherein the instructions, when executed by the at least one processor, cause the apparatus at least to store the information related to the usability of the at least one image with an artificial intelligence model within at least one or more of: a file format, or an International Organization for Standardization base media file format (ISOBMFF), or a media description, or a dynamic adaptive streaming over hypertext transfer protocol media presentation description.

Example 24. An apparatus including: at least one processor; and at least one memory storing instructions that, when executed by the at least one processor, cause the apparatus at least to: receive signaling of information related to a usability of at least one image with an artificial intelligence model; and determine whether to use the at least one image with an artificial intelligence model, based on the received signaling.

Example 25. The apparatus of example 24, wherein the usability of the at least one image indicates an extent to which the at least one image is usable with an artificial intelligence model, unusable with an artificial intelligence model, suitable for use with an artificial intelligence model, or unsuitable for use with an artificial intelligence model.

Example 26. The apparatus of any of examples 24 to 25, wherein the artificial intelligence model is a statistical model.

Example 27. The apparatus of any of examples 24 to 26, wherein the signaled information indicates that the at least one image was altered using a process that makes the at least one image unsuitable or unusable for training an artificial intelligence model or as input to an artificial intelligence model for inference.

Example 28. The apparatus of any of examples 24 to 27, wherein the signaled information indicates that the at least one image has been encoded in a way that makes the at least one image usable or suitable for training an artificial intelligence model or as input to an artificial intelligence model for inference.

Example 29. The apparatus of any of examples 24 to 28, wherein the signaled information indicates to what extent the at least one image is usable, suitable, unusable, or unsuitable for training an artificial intelligence model or as input to an artificial intelligence model for inference.

Example 30. The apparatus of any of examples 24 to 29, wherein the signaled information indicates that the extent to which the at least one image is usable, suitable, unusable, or unsuitable for training an artificial intelligence model or as input to an artificial intelligence model for inference is unknown.

Example 31. The apparatus of any of examples 24 to 30, wherein the artificial intelligence model for which the information related to the usability of the at least one image with an artificial intelligence model is signaled comprises one of: a computer vision task, wherein the computer vision task comprises object detection, instance segmentation, or object tracking, or an end-to-end compression neural network, or a view synthesis model, or a generative artificial intelligence model.

Example 32. The apparatus of any of examples 24 to 31, wherein the instructions, when executed by the at least one processor, cause the apparatus at least to: determine the information related to the usability of the at least one image with an artificial intelligence model from an artificial intelligence usability box syntax element.

Example 33. The apparatus of example 32, wherein the artificial intelligence usability box syntax element comprises at least one one-bit indication that indicates to what extent the at least one image is usable or unusable with an artificial intelligence model.

Example 34. The apparatus of any of examples 32 to 33, wherein the artificial intelligence usability box syntax element comprises at least one or more of: a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image, making the item or track unusable or harmful for an artificial intelligence model, or a valid for computer vision flag, wherein a value for the valid for computer vision flag being equal to 1 indicates that the item or track associated with the at least one image can be used for computer vision tasks, or a valid for neural network transcoding flag, wherein a value for the valid for neural network transcoding flag being equal to 1 indicates that the item or track associated with the at least one image can be transcoded using neural networks, or a valid for inference flag, wherein a value for the valid for inference flag being equal to 1 indicates that the item or track associated with the at least one image can be processed with a trained neural network.

Example 35. The apparatus of any of examples 32 to 34, wherein the artificial intelligence usability box syntax element is an item property that can be attached to an image item associated with the at least one image, wherein the item property describes the image item.

Example 36. The apparatus of any of examples 32 to 35, wherein the instructions, when executed by the at least one processor, cause the apparatus at least to: determine the artificial intelligence usability box syntax element from a metabox syntax element; wherein the metabox syntax element describes a file, and the information related to the usability of the at least one image with an artificial intelligence model is applicable to the file.

Example 37. The apparatus of example 36, wherein the metabox syntax element comprises an item properties box containing an item property container box, and the item property container box comprises 16 entries, wherein one of the 16 entries includes the information related to the usability of the at least one image with an artificial intelligence model.

Example 38. The apparatus of any of examples 24 to 37, wherein the instructions, when executed by the at least one processor, cause the apparatus at least to: determine the information related to the usability of the at least one image with an artificial intelligence model from a track level syntax structure, wherein the track level syntax structure is a child box of a track box syntax element, a media box syntax element, or a sample entry.

Example 39. The apparatus of any of examples 24 to 38, wherein the instructions, when executed by the at least one processor, cause the apparatus at least to: determine the information related to the usability of the at least one image with an artificial intelligence model from a scheme information syntax element; wherein the scheme information syntax element indicates: a scheme used to protect the at least one image from an artificial intelligence model, or that the at least one image is protected from an artificial intelligence model.

Example 40. The apparatus of any of examples 24 to 39, wherein the instructions, when executed by the at least one processor, cause the apparatus at least to: determine the information related to the usability of the at least one image with an artificial intelligence model from an artificial intelligence usability box, wherein an extended meta payload within a minimized image box contains the artificial intelligence usability box, wherein the extended meta payload has no artificial intelligence usability box entries for items 1 to 16 of the extended meta payload.

Example 41. The apparatus of any of examples 24 to 40, wherein the instructions, when executed by the at least one processor, cause the apparatus at least to: determine the information related to the usability of the at least one image with an artificial intelligence model from an extended meta payload, wherein the extended meta payload is within a minimized image box.

Example 42. The apparatus of example 41, wherein the extended meta payload comprises at least one or more of: a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image making the item or track unusable or harmful for artificial intelligence model, or a valid for computer vision flag, wherein a value for the valid for computer vision flag being equal to 1 indicates that the item or track associated with the at least one image can be used for computer vision tasks, or a valid for neural network transcoding flag, wherein a value for the valid for neural network transcoding being equal to 1 indicates that the item or track associated with the at least one image can be transcoded using neural networks, or a valid for inference flag wherein a value for the valid for inference flag being equal to 1 indicates that the item or track associated with the at least one image can be processed with a trained neural network.

Example 43. The apparatus of any of examples 24 to 42, wherein the instructions, when executed by the at least one processor, cause the apparatus at least to: determine the information related to the usability of the at least one image with an artificial intelligence model from a descriptor within a representation or adaptation set, wherein the representation or adaptation set is within a media presentation description.

Example 44. The apparatus of example 43, wherein the media presentation description is defined based on ISO/IEC 23009-1 (DASH).

Example 45. The apparatus of any of examples 24 to 44, wherein the instructions, when executed by the at least one processor, cause the apparatus at least to determine the information related to the usability of the at least one image with an artificial intelligence model from at least one or more of: a supplemental enhancement information message, or an encoder optimization information supplemental enhancement information message.

Example 46. The apparatus of any of examples 24 to 45, wherein the instructions, when executed by the at least one processor, cause the apparatus at least to determine the information related to the usability of the at least one image with an artificial intelligence model from at least one or more of: a file format, or an International Organization for Standardization base media file format (ISOBMFF), or a media description, or a dynamic adaptive streaming over hypertext transfer protocol media presentation description.

Example 47. A method including: determining information related to a usability of at least one image with an artificial intelligence model; and signaling the information related to the usability of the at least one image with an artificial intelligence model.

Example 48. A method including: receiving signaling of information related to a usability of at least one image with an artificial intelligence model; and determining whether to use the at least one image with an artificial intelligence model, based on the received signaling.

Example 49. An apparatus including: means for determining information related to a usability of at least one image with an artificial intelligence model; and means for signaling the information related to the usability of the at least one image with an artificial intelligence model.

Example 50. An apparatus including: means for receiving signaling of information related to a usability of at least one image with an artificial intelligence model; and means for determining whether to use the at least one image with an artificial intelligence model, based on the received signaling.

Example 51. A computer readable medium including instructions stored thereon for performing at least the following: determining information related to a usability of at least one image with an artificial intelligence model; and signaling the information related to the usability of the at least one image with an artificial intelligence model.

Example 52. A computer readable medium including instructions stored thereon for performing at least the following: receiving signaling of information related to a usability of at least one image with an artificial intelligence model; and determining whether to use the at least one image with an artificial intelligence model, based on the received signaling.

In the above, some embodiments have been described with reference to SEI messages. It needs to be understood that embodiments may be similarly realized with any other similar syntax structures, such as metadata OBUs or registered ITU-T T.35 metadata.

In the above, some example embodiments have been described with the help of syntax elements and/or syntax structures, e.g. for an SEI message, file format, or media description. It needs to be understood, however, that the corresponding structure and/or computer program may reside at an entity for generating an instance of the syntax structure and/or at an entity for decoding or interpreting an instance of the syntax structure. Likewise, it needs to be understood that corresponding embodiments for generating or encoding syntax elements and/or syntax structures may be realized by including encoding steps for creating the particular syntax elements and/or syntax structures. Similarly, it needs to be understood that corresponding embodiments for decoding or interpreting syntax elements and/or syntax structures may be realized by including decoding or interpreting steps for reading the particular syntax elements and/or syntax structures.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number, and may be case insensitive):
2D two-dimensional
3D three-dimensional
3GP 3GPP file format
3GPP third generation partnership project
4CC four character code
AI artificial intelligence
AHS adaptive HTTP streaming
AMVP advanced motion vector prediction
AOM Alliance for Open Media
APS adaptation parameter set
ASIC application specific integrated circuit
AV1, AV2 video coding formats from the Alliance for Open Media
AVC advanced video coding
CC character code
CDN content delivery network
CLVS coded layer video sequence
CPU central processing unit
CTU coding tree unit
CVS coded video sequence
DASH dynamic adaptive streaming over HTTP
DCT discrete cosine transform
DRM digital rights management
EOI encoder optimization information
Exp exponential
FPGA field programmable gate array
GOP group of pictures
H.2xx family of video coding standards in the domain of the ITU-T (e.g. H.264, H.265, H.266, H.274)
HEIF high efficiency image file format
HEVC high efficiency video coding
HLS high level syntax
HTTP hypertext transfer protocol
IBC intra block copy
ICC International Color Consortium
ID identifier
ide indicator
IEC international electrotechnical commission
IEEE Institute of Electrical and Electronics Engineers
IETF Internet Engineering Task Force
I/F interface
I/O input/output
IoT internet of things
ISO International Organization for Standardization
ISOBMFF ISO base media file format
ITU International Telecommunication Union
ITU-T ITU Telecommunication Standardization Sector
JCT-VC joint collaborative team video coding
JVT joint video team
MCTS motion constrained tile set
MIAF multi-image application format
MPD media presentation description
MPEG moving or motion picture experts group
MPEG-I MPEG immersive
MSE mean squared error
MV multiview
MVC multiview video coding
NAL network abstraction layer
NN neural network
nuh NAL unit header
N/W network
OBU open bitstream unit
POC picture order count
PPS picture parameter set
PU prediction unit
PSNR peak signal-to-noise ratio
PSS packet-switched streaming
RAM random access memory
RAP random access point
RBSP raw byte sequence payload
REXT range extension
RFC request for comments
ROM read only memory
SAP stream access point
SEI supplemental enhancement information
SHVC scalable high efficiency video coding
SON self-organizing/optimizing network
SPS sequence parameter set
SSIM structural similarity index measure
SVC scalable video coding
T.35 procedure for the allocation of ITU-T defined codes for non-standard facilities
TID temporal layer identifier
TMVP temporal motion vector prediction
TS technical specification
ue(v) unsigned integer 0-th order Exp-Golomb-coded syntax element with the left bit first
UI user interface
u(n) unsigned integer using n bits
URI uniform resource identifier
URL uniform resource locator
URN uniform resource name
USB universal serial bus
v version
VCL video coding layer
VCEG video coding experts group
VPS video parameter set
VSEI versatile supplemental enhancement information
VUI video usability information
VVC versatile video coding
XML extensible markup language
XMP extensible metadata platform

1. An apparatus comprising:
at least one processor; and
at least one memory storing instructions that, when executed by the at least one processor, cause the apparatus at least to:
determine information related to a usability of at least one image with an artificial intelligence model; and
signal the information related to the usability of the at least one image with an artificial intelligence model.

2. The apparatus of claim 1, wherein the usability of the at least one image indicates an extent to which the at least one image is usable with an artificial intelligence model, unusable with an artificial intelligence model, suitable for use with an artificial intelligence model, or unsuitable for use with an artificial intelligence model.

3. (canceled)

4. The apparatus of claim 1, wherein the signaled information indicates that the at least one image was altered using a process that makes the at least one image unsuitable or unusable for training an artificial intelligence model or as input to an artificial intelligence model for inference.

5. The apparatus of claim 1, wherein the signaled information indicates that the at least one image has been encoded in a way that makes the at least one image usable or suitable for training an artificial intelligence model or as input to an artificial intelligence model for inference.

6. The apparatus of claim 1, wherein the signaled information indicates to what extent the at least one image is usable, suitable, unusable, or unsuitable for training an artificial intelligence model or as input to an artificial intelligence model for inference.

7. The apparatus of claim 1, wherein the signaled information indicates that the extent to which the at least one image is usable, suitable, unusable, or unsuitable for training an artificial intelligence model or as input to an artificial intelligence model for inference is unknown.

8. The apparatus of claim 1, wherein the artificial intelligence model for which the information related to the usability of the at least one image with an artificial intelligence model is signaled comprises one of:
a computer vision task, wherein the computer vision task comprises object detection, instance segmentation, or object tracking, or
an end-to-end compression neural network, or
a view synthesis model, or
a generative artificial intelligence model.

9. The apparatus of claim 1, wherein the at least one memory stores instructions that, when executed by the at least one processor, cause the apparatus at least to:
store the information related to the usability of the at least one image with an artificial intelligence model within an artificial intelligence usability box syntax element.

10. The apparatus of claim 9, wherein the artificial intelligence usability box syntax element comprises at least one one-bit indication that indicates to what extent the at least one image is usable or unusable with an artificial intelligence model.

11. The apparatus of claim 9, wherein the artificial intelligence usability box syntax element comprises at least one or more of:
a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image, making the item or track unusable or harmful for an artificial intelligence model, or
a valid for computer vision flag, wherein a value for the valid for computer vision flag being equal to 1 indicates that the item or track associated with the at least one image can be used for computer vision tasks, or
a valid for neural network transcoding flag, wherein a value for the valid for neural network transcoding flag being equal to 1 indicates that the item or track associated with the at least one image can be transcoded using neural networks, or
a valid for inference flag, wherein a value for the valid for inference flag being equal to 1 indicates that the item or track associated with the at least one image can be processed with a trained neural network.

12. The apparatus of claim 9, wherein the artificial intelligence usability box syntax element is an item property that can be attached to an image item associated with the at least one image, wherein the item property describes the image item.

13. The apparatus of claim 9, wherein the at least one memory stores instructions that, when executed by the at least one processor, cause the apparatus at least to:
store the artificial intelligence usability box syntax element within a metabox syntax element;
wherein the metabox syntax element describes a file, and the information related to the usability of the at least one image with an artificial intelligence model is applicable to the file;
wherein the metabox syntax element comprises an item properties box containing an item property container box, and the item property container box comprises 16 entries, wherein one of the 16 entries includes the information related to the usability of the at least one image with an artificial intelligence model.

14. (canceled)

15. The apparatus of claim 1, wherein the at least one memory stores instructions that, when executed by the at least one processor, cause the apparatus at least to:
store the information related to the usability of the at least one image with an artificial intelligence model within a track level syntax structure, wherein the track level syntax structure is a child box of a track box syntax element, a media box syntax element, or a sample entry.

16. The apparatus of claim 1, wherein the at least one memory stores instructions that, when executed by the at least one processor, cause the apparatus at least to:
store the information related to the usability of the at least one image with an artificial intelligence model within a scheme information syntax element;
wherein the scheme information syntax element indicates: a scheme used to protect the at least one image from an artificial intelligence model, or that the at least one image is protected from an artificial intelligence model.

17. The apparatus of claim 1, wherein the at least one memory stores instructions that, when executed by the at least one processor, cause the apparatus at least to:
store the information related to the usability of the at least one image with an artificial intelligence model within an artificial intelligence usability box, wherein an extended meta payload within a minimized image box contains the artificial intelligence usability box, wherein the extended meta payload has no artificial intelligence usability box entries for items 1 to 16 of the extended meta payload.

18. The apparatus of claim 1, wherein the instructions, when executed by the at least one processor, cause the apparatus at least to store the information related to the usability of the at least one image with an artificial intelligence model within an extended meta payload, wherein the extended meta payload is within a minimized image box, wherein the extended meta payload comprises at least one or more of:
a valid for training flag, wherein a value for the valid for training flag being equal to 1 indicates that an item or track associated with the at least one image can be used for training an artificial intelligence model, and a value for the valid for training flag being equal to 0 indicates that an algorithm has been applied on the item or track associated with the at least one image making the item or track unusable or harmful for artificial intelligence model, or
a valid for computer vision flag, wherein a value for the valid for computer vision flag being equal to 1 indicates that the item or track associated with the at least one image can be used for computer vision tasks, or
a valid for neural network transcoding flag, wherein a value for the valid for neural network transcoding being equal to 1 indicates that the item or track associated with the at least one image can be transcoded using neural networks, or
a valid for inference flag wherein a value for the valid for inference flag being equal to 1 indicates that the item or track associated with the at least one image can be processed with a trained neural network.

19. (canceled)

20. The apparatus of claim 1, wherein the at least one memory stores instructions that, when executed by the at least one processor, cause the apparatus at least to:
store the information related to the usability of the at least one image with an artificial intelligence model as a descriptor within a representation or adaptation set, wherein the representation or adaptation set is within a media presentation description;
wherein the media presentation description is defined based on ISO/IEC 23009-1 (DASH).

21. (canceled)

22. The apparatus of claim 1, wherein the at least one memory stores instructions that, when executed by the at least one processor, cause the apparatus at least to store the information related to the usability of the at least one image with an artificial intelligence model within at least one or more of:
a supplemental enhancement information message, or
an encoder optimization information supplemental enhancement information message, or
a file format, or
an International Organization for Standardization base media file format (ISOBMFF), or
a media description, or
a dynamic adaptive streaming over hypertext transfer protocol media presentation description.

23. (canceled)

24. An apparatus comprising:
at least one processor; and
at least one memory storing instructions that, when executed by the at least one processor, cause the apparatus at least to:
receive signaling of information related to a usability of at least one image with an artificial intelligence model; and
determine whether to use the at least one image with an artificial intelligence model, based on the received signaling.

25.-46. (canceled)

47. A method comprising:
determining information related to a usability of at least one image with an artificial intelligence model; and
signaling the information related to the usability of the at least one image with an artificial intelligence model.

48.-52. (canceled)

53. The apparatus of claim 1, wherein the at least one memory stores instructions that, when executed by the at least one processor, cause the apparatus at least to:
signal, within a supplemental enhancement information message, a syntax element indicating to what extent at least one image within a scope of the supplemental enhancement information message is suitable for training of artificial intelligence models, or for inference using artificial intelligence models, or for generative artificial intelligence.

54. The apparatus of claim 1, wherein the at least one memory stores instructions that, when executed by the at least one processor, cause the apparatus at least to:
signal, within a supplemental enhancement information message, a syntax element related to usability of the at least one image for training artificial intelligence models, or for inference using artificial intelligence models, or for generative artificial intelligence;
wherein a first value of the syntax element specifies that the at least one image has been optimized to be used for training artificial intelligence models, or for inference using artificial intelligence models, or for generative artificial intelligence;
wherein a second value of the syntax element specifies that the at least one image is suitable but not specifically optimized to be used for training artificial intelligence models, or for inference using artificial intelligence models, or for generative artificial intelligence;
wherein a third value of the syntax element specifies that the at least one image is not suitable for training artificial intelligence models, or for inference using artificial intelligence models, or for generative artificial intelligence;
wherein a fourth value of the syntax element specifies that it is unknown whether the at least one image is suitable for training artificial intelligence models, or for inference using artificial intelligence models, or for generative artificial intelligence.

55. The apparatus of claim 1, wherein the at least one memory stores instructions that, when executed by the at least one processor, cause the apparatus at least to:
signal, within a supplemental enhancement information message, an optimization type that indicates artificial intelligence usability information;
wherein a value of an optimization type bit of the optimization type of the supplemental enhancement information message indicates that the at least one image has been preprocessed or encoded such that the at least one image is unsuitable for training artificial intelligence models, or for inference using artificial intelligence models, or for generative artificial intelligence.

56. The apparatus of claim 1, wherein the at least one memory stores instructions that, when executed by the at least one processor, cause the apparatus at least to:
signal a supplemental enhancement information message that indicates that the at least one image has been optimized or is suitable or is unsuitable to be used for training artificial intelligence models, or for inference using artificial intelligence models, or for generative artificial intelligence;
wherein the supplemental enhancement information message comprises a characterization of the artificial intelligence models that optimization information of the supplemental enhancement information concerns.

57. The apparatus of claim 1, wherein the at least one memory stores instructions that, when executed by the at least one processor, cause the apparatus at least to:
signal an artificial intelligence usability information descriptor of a representation set or an adaptation set;
wherein the artificial intelligence usability information descriptor contains child elements that indicate usability of the at least one image for different tasks;
wherein the artificial intelligence usability information descriptor is included at a media presentation description level, or at a period level, or at a preselection level, or at an adaptation level, or at a representation level, or at a sub-representation level.
